(19) United States
(12) Patent Application Publication
(10) Pub. No.: US 2007/0184018 A1
(43) Pub. Date: Aug. 9, 2007

(54) Anthranilamide insecticides

(76) Inventors: George Philip Lahm, Wilmington, DE (US); Thomas Paul Selby, Hockessin, DE (US)

Correspondence Address: Linda D Birch;E I du Pont de Nemours and Company, 4417 Lancaster Pike, Wilmington, DE, 19805, US

(21) Appl. No.: 10/591,200

(22) PCT Filed: Apr. 12, 2005
(86) PCT No.: PCT/US05/12465

§ 371 Date: Aug. 30, 2006

Related U.S. Application Data
(60) Provisional application No. 60/561,813, filed on Apr. 13, 2004.

(51) Int. Cl. A01N 43/56

(52) U.S. Cl. 424/84; 514/403; 548/375.1

(57) ABSTRACT

This invention provides compounds of Formula (1), N oxides and suitable salts thereof, wherein R¹ is Me, Cl, Br or I; R² is Cl, Br, I or —CN; R³ is Cl, Br, CF₃, OCH₂CF₃ or OCF₂H; R⁴ is H; or C₁₋₄alkyl, C₂₋₄alkenyl or C₂₋₄alkynyl, each optionally substituted with CN or Sme; and R⁵ is phenyl substituted with 1 to 3 substituents selected from the group consisting of F, Cl, Br and Me. Also disclosed are methods for controlling an invertebrate pest comprising contacting the invertebrate pest or its environment with a biologically effective amount of a compound of Formula (1), an N-oxide thereof or a suitable salt of the compound (e.g., as a composition described herein). This invention also pertains to a composition for controlling an invertebrate pest comprising a biologically effective amount of a compound of Formula (1), an N-oxide thereof or a suitable salt of the compound and at least one additional component selected from the group consisting of a surfactant, a solid diluent and a liquid diluent.

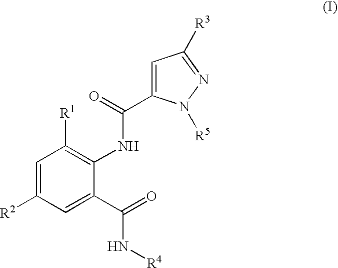

### FIELD OF THE INVENTION

This invention relates to certain anthranilamides, their N-oxides, salts and compositions suitable for agronomic and nonagronomic uses, including those uses listed below, and a method of their use for controlling invertebrate pests in both agronomic and nonagronomic environments.

### BACKGROUND OF THE INVENTION

The control of invertebrate pests is extremely important in achieving high crop efficiency. Damage by invertebrate pests to growing and stored agronomic crops can cause significant reduction in productivity and thereby result in increased costs to the consumer. The control of invertebrate pests in forestry, greenhouse crops, ornamentals, nursery crops, stored food and fiber products, livestock, household, and public and animal health is also important. Many products are commercially available for these purposes, but the need continues for new compounds that are more effective, less costly, less toxic, environmentally safer or have different modes of action.

WO 01/070671 discloses N-acyl anthranilic acid derivatives of Formula i as arthropodicides 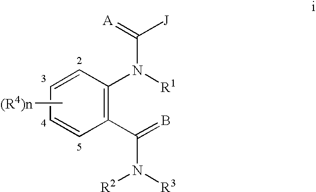
wherein, inter alia, A and B are independently O or S; J is an optionally substituted phenyl ring, 5- or 6-membered heteroaromatic ring, naphthyl ring system or an aromatic 8-, 9- or 10-membered fused heterobicyclic ring system; R¹ and R³ are independently H or optionally substituted C₁-C₆ alkyl; R² is H or C₁-C₆ alkyl; each R⁴ is independently H, C₁-C₆ alkyl, C₁-C₆ haloalkyl, halogen or CN; and n is 1 to 4.

### SUMMARY OF THE INVENTION

This invention is directed to compounds of Formula 1 including all geometric and stereoisomers, N-oxides, and agronomic or nonagronomic salts thereof, agricultural and nonagricultural compositions which include them and their use for controlling invertebrate pests: 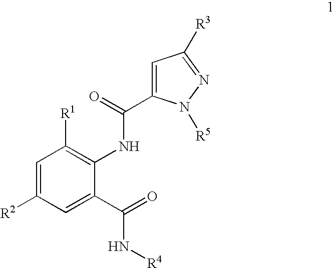
wherein
R¹ is Me, Cl, Br or I;
R² is Cl, Br, I or —CN;
R³ is Cl, Br, CF₃, OCH₂CF₃, or OCF₂H;
R⁴ is H; or C₁-C₄ alkyl, C₂-C₄ alkenyl or C₂-C₄ alkynyl, each optionally substituted with CN or SMe; and
R⁵ is phenyl substituted with 1 to 3 substituents selected from the group consisting of F, Cl, Br and Me.

This invention also provides a composition for controlling an invertebrate pest comprising a biologically effective amount of a compound of Formula 1 and at least one additional component selected from the group consisting of a surfactant, a solid diluent and a liquid diluent. This invention also pertains to a composition comprising a biologically effective amount of a compound of Formula 1 and an effective amount of at least one additional biologically active compound or agent.

This invention also provides a method for controlling an invertebrate pest comprising contacting the invertebrate pest or its environment with a biologically effective amount of a compound of Formula 1 (e.g., as a composition described herein). This invention also relates to such method wherein the invertebrate pest or its environment is contacted with a biologically effective amount of a compound of Formula 1 or a composition comprising a compound of Formula 1 and a biologically effective amount of at least one additional compound or agent for controlling invertebrate pests.

### DETAILS OF THE INVENTION

As used herein, the terms “comprises,” “comprising,” “includes,” “including,” “has,” “having” or any other variation thereof, are intended to cover a non-exclusive inclusion. For example, a composition, process, method, article, or apparatus that comprises a list of elements is not necessarily limited to only those elements but may include other elements not expressly listed or inherent to such composition, process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of “a” or “an” are employed to describe elements and components of the invention. This is done merely for convenience and to give a general sense of the invention. This description should be read to include one or at least one and the singular also includes the plural unless it is obvious that it is meant otherwise.

In the above recitations, the total number of carbon atoms in a substituent group is indicated by the “Cᵢ-Cⱼ” prefix where i and j are numbers from 1 to 4. The term “alkyl” includes straight-chain or branched alkyl. For example, C₁-C₄ alkyl designates methyl, ethyl, n-propyl, i-propyl, or the different butyl isomers. “Alkenyl” includes straight-chain or branched alkenes such as ethenyl, 1-propenyl, 2-propenyl, and the different butenyl isomers. “Alkenyl” also includes polyenes such as 1,2-propadienyl. “Alkynyl” includes straight-chain or branched alkynes such as ethynyl, 1-propynyl, 2-propynyl and the different butynyl isomers. “Alkynyl” can also include moieties comprised of multiple triple bonds such as 1,3-butadiynyl.

One skilled in the art will appreciate that not all nitrogen-containing heterocycles can form N-oxides since the nitrogen requires an available lone pair for oxidation to the oxide; one skilled in the art will recognize those nitrogen-containing heterocycles which can form N-oxides. One skilled in the art will also recognize that tertiary amines can form N-oxides. Synthetic methods for the preparation of N-oxides of heterocycles and tertiary amines are very well known by one skilled in the art including the oxidation of heterocycles and tertiary amines with peroxy acids such as peracetic and m-chloroperbenzoic acid (MCPBA), hydrogen peroxide, alkyl hydroperoxides such as t-butyl hydroperoxide, sodium perborate, and dioxiranes such as dimethydioxirane. These methods for the preparation of N-oxides have been extensively described and reviewed in the literature, see for example: T. L. Gilchrist in Comprehensive Organic Synthesis, vol. 7, pp 748-750, S. V. Ley, Ed., Pergamon Press; M. Tisler and B. Stanovnik in Comprehensive Heterocyclic Chemistry, vol. 3, pp 18-20, A. J. Boulton and A. McKillop, Eds., Pergamon Press; M. R. Grinumett and B. R. T. Keene in Advances in Heterocyclic Chemistry, vol. 43, pp 149-161, A. R. Katritzky, Ed., Academic Press; M. Tisler and B. Stanovnik in Advances in Heterocyclic Chemistry, vol. 9, pp 285-291, A. R. Katritzky and A. J. Boulton, Eds., Academic Press; and G. W. H. Cheeseman and E. S. G. Werstiuk in Advances in Heterocyclic Chemistry, vol. 22, pp 390-392, A. R. Katritzky and A. J. Boulton, Eds., Academic Press.

Compounds of this invention can exist as one or more stereoisomers. The various stereoisomers include enantiomers, diastereomers, atropisomers and geometric isomers. One skilled in the art will appreciate that one stereoisomer may be more active or may exhibit beneficial effects when enriched relative to the other stereoisomer(s) or when separated from the other stereoisomer(s). Additionally, the skilled artisan knows how to separate, enrich, and/or to selectively prepare said stereoisomers. Accordingly, the present invention comprises compounds selected from Formula 1, N-oxides and agriculturally suitable salts thereof. The compounds of the invention may be present as a mixture of stereoisomers, individual stereoisomers, or as an optically active form.

The salts of the compounds of the invention include acid-addition salts with inorganic or organic acids such as hydrobromic, hydrochloric, nitric, phosphoric, sulfuric, acetic, butyric, fumaric, lactic, maleic, malonic, oxalic, propionic, salicylic, tartaric, 4-toluenesulfonic or valeric acids.

Embodiments of the present invention include:
Embodiment 1. A compound of Formula 1, an N-oxide or a suitable salt thereof, wherein R¹ is Me, Cl or Br.
Embodiment 2. The compound of Embodiment 1 wherein R¹ is Me or Cl.
Embodiment 3. The compound of Embodiment 2 wherein R¹ is Me.
Embodiment 4. The compound of Embodiment 2 wherein R¹ is Cl.
Embodiment 5. A compound of Formula 1, an N-oxide or a suitable salt thereof, wherein R² is Cl, Br or —CN.
Embodiment 6. The compound of Embodiment 5 wherein R² is Cl or —CN.
Embodiment 7. The compound of Embodiment 6 wherein R² is Cl.
Embodiment 8. The compound of Embodiment 6 wherein R² is —CN.
Embodiment 9. A compound of Formula 1, an N-oxide or a suitable salt thereof, wherein R³ is Cl, Br or CF₃.
Embodiment 10. A compound of Formula 1, an N-oxide or a suitable salt thereof, wherein R³ is OCH₂CF₃ or OCF₂H.
Embodiment 11. A compound of Formula 1, an N-oxide or a suitable salt thereof, wherein R⁴ is H or C₁-C₄ alkyl optionally substituted with CN or SMe.
Embodiment 12. The compound of Embodiment 11 wherein R⁴ is H.
Embodiment 13. The compound of Embodiment 11 wherein R⁴ is C₁-C₄ alkyl.
Embodiment 14. The compound of Embodiment 13 wherein R⁴ is Me, Et, i-Pr or t-Bu.
Embodiment 15. A compound of Formula 1, an N-oxide or a suitable salt thereof, wherein R⁵ is 2-chlorophenyl, 2-fluorophenyl, 2-bromophenyl, 2,4-dichlorophenyl, 2-chloro-4-fluorophenyl, 2,6-dichlorophenyl, 2,6-difluorophenyl or 2,4,6-trichlorophenyl.

Combinations of Embodiments 1-15 are illustrated by:
Embodiment A. A compound of Formula 1 above, an N-oxide or a suitable salt thereof, wherein
   R² is Cl;
   R³ is Cl, Br or CF₃;
   R⁴ is Me, Et, i-Pr or t-Bu; and
   R⁵ is 2-chlorophenyl, 2-fluorophenyl, 2-bromophenyl, 2,4-dichlorophenyl, 2-chloro-4-fluorophenyl, 2,6-dichlorophenyl, 2,6-difluorophenyl or 2,4,6-trichlorophenyl.
Embodiment B. A compound of Formula 1 above, an N-oxide or a suitable salt thereof, wherein
   R² is —CN;
   R³ is Cl, Br or CF₃;
   R⁴ is Me, Et, i-Pr or t-Bu; and
   R⁵ is 2-chlorophenyl, 2-fluorophenyl, 2-bromophenyl, 2,4-dichlorophenyl, 2-chloro-4-fluorophenyl, 2,6-dichlorophenyl, 2,6-difluorophenyl or 2,4,6-trichlorophenyl.

This invention also provides a composition for controlling an invertebrate pest comprising a biologically effective amount of a compound of Formula 1, an N-oxide thereof or an agronomic or nonagronomic suitable salt thereof and at least one additional component selected from the group consisting of a surfactant, a solid diluent and a liquid diluent, said composition optionally further comprising an effective amount of at least one additional biologically active compound or agent. Embodiments of compositions of the present invention include those which comprise the above compounds of Embodiments 1-15 and A and B.

This invention also provides a method for controlling an invertebrate pest comprising contacting the invertebrate pest or its environment with a biologically effective amount of a compound of Formula 1, an N-oxide thereof or an agronomic or nonagronomic suitable salt thereof or with a biologically effective amount of the present composition described herein. Embodiments of methods of use include those involving the above compounds of Embodiments 1-15 and A and B.

The compounds of Formula 1 can be prepared by one or more of the following methods and variations as described in Schemes 1-12. The definitions of R¹, R², R³, R⁴, and R⁵ in the compounds of Formulae 1-21 below are as defined above in the Summary of the Invention unless indicated otherwise.

Compounds of Formula 1 can be prepared by the reaction of benzoxazinones of Formula 2 with amines of formula H₂NR⁴ as outlined in Scheme 1. The reaction can be run neat or in a variety of suitable solvents including tetrahydrofuran, diethyl ether, dioxane, ethyl acetate, methylene chloride or chloroform, with optimum temperatures ranging from 0° C. to the reflux temperature of the solvent. The method of Scheme 1 is illustrated in Examples 1 and 2. The general reaction of benzoxazinones with amines to produce anthranilamides is well documented in the chemical literature. For a review of benzoxazinone chemistry see Jakobsen et al, Biorganic and Medicinal Chemistry, 2000, 8, 2095-2103 and references cited within. See also Coppola, J. Heterocyclic Chemistry, 1999, 36, 563-588.

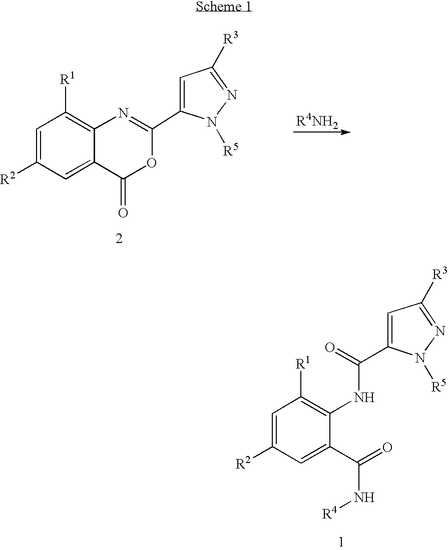

Compounds of Formula 1 can also be prepared by the reaction of amides of Formula 3 with pyrazole acid chlorides of Formula 4 as outlined in Scheme 2. The reaction can be run in a variety of suitable solvents including diethyl ether, dioxane, tetrahydrofuran, ethyl acetate, methylene chloride or chloroform, with optimum temperatures ranging from 0° C. to the reflux temperature of the solvent. An amine base such as pyridine, triethylamine or N,N-diisopropylethylamine is generally added to facilitate the reaction. The acid chlorides of Formula 4 are available from the corresponding acids of Formula 6 by known methods such as chlorination with thionyl chloride or oxalyl chloride.

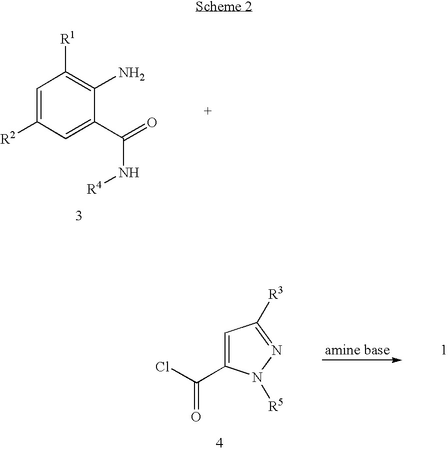

Benzoxazinones of Formula 2 can be prepared by a variety of procedures. In Scheme 3, benzoxazinones are prepared directly via coupling of an anthranilic acid of Formula 5 with a pyrazole acid of Formula 6. This method involves mixing the anthranilic and pyrazole acids in solvents such as acetonitrile, followed by sequential addition of 3-picoline and methanesulfonyl chloride. Preferred temperatures fall in the range of −10° C. to room temperature. This procedure generally affords good yields of the benzoxazinone of Formula 2 and is illustrated in Example 1 (Step H).

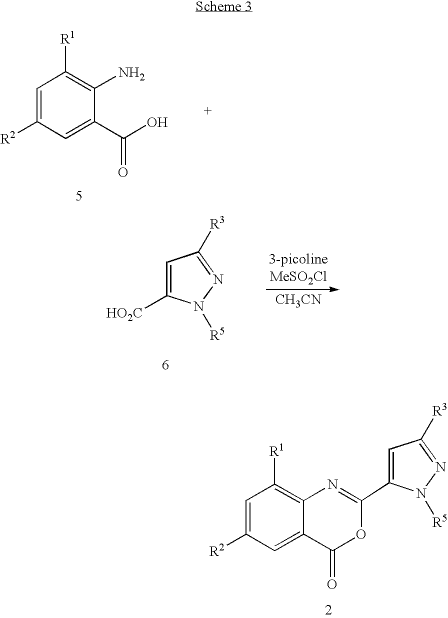

As shown in Scheme 4, an alternate preparation for benzoxazinones of Formula 2 involves coupling of a pyrazole acid chloride of Formula 4 with an isatoic anhydride of Formula 7 to provide the Formula 2 benzoxazinone directly. Solvents such as pyridine or pyridine/acetonitrile are suitable for this reaction.

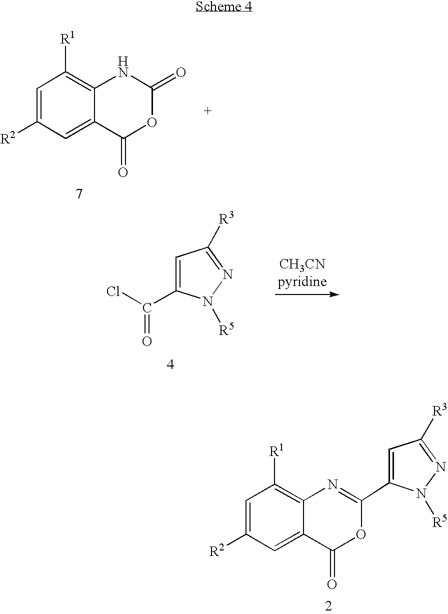

Anthranilic amides of Formula 3 are available by a variety of known methods. A general procedure is shown in Scheme 5 and involves reaction of the isatoic anhydride of Formula 7 with an amine to provide the anthranilic amide of Formula 3 directly.

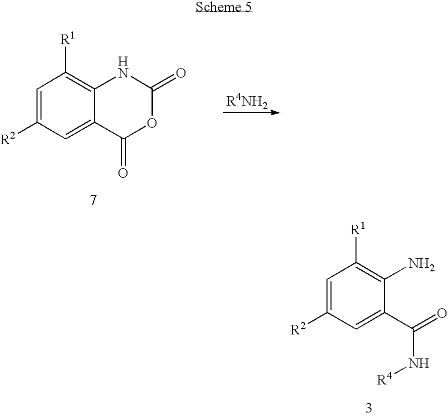

Anthranilic acids of Formula 5 are available by a variety of known methods. Many of these compounds are known. Anthranilic acids containing an R² substituent of chloro, bromo and iodo can be prepared by direct halogenation of an unsubstituted anthranilic acid of Formula 8 with either N-chlorosuccinimide, N-bromosuccinimide or N-iodosuccinimide respectively to produce the corresponding substituted acid of Formula 5.

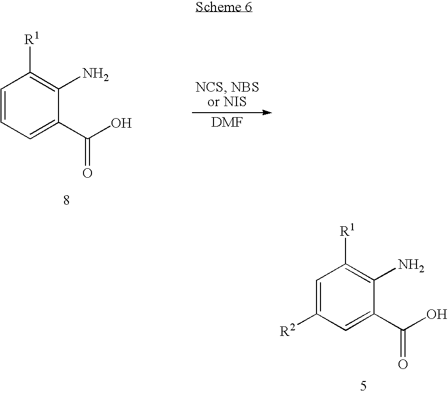

Compounds of Formula 1, where R² is cyano, is one embodiment of this invention. The required anthranilic acid intermediates of Formula 5a (Formula 5 where R² is cyano), can be prepared from the corresponding iodo or bromo derivatives of Formula 8a by displacement with cyanide. Treatment with copper cyanide in N,N-dimethylformamide is well documented in the literature as a useful method for this conversion. This method is shown in Scheme 7 and further illustrated in Example 1 (Step G).

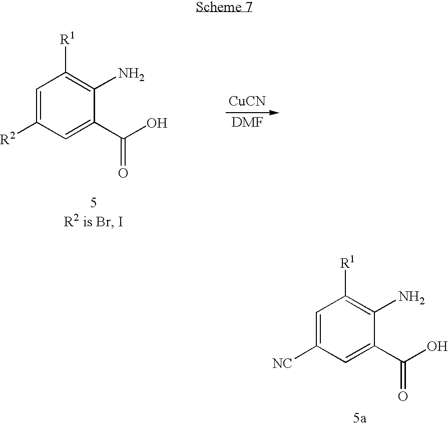

Pyrazole acids of Formula 6, where R³ is Cl, Br or CF₃, can be prepared by the method outlined in Scheme 8. This sequence can be accomplished in several steps from hydrazonyl halides of Formula 10. Cycloaddition of 10 with methyl acrylate affords a pyrazoline of Formula 11 with good regiospecificity for the desired isomer. Oxidation of 11 can be achieved with a variety of oxidative reagents including but not limited to hydrogen peroxide, organic peroxides, potassium monopersulfate (e.g., Oxone®), potassium persulfate, sodium persulfate, ammonium persulfate, or potassium permanganate. The pyrazole ester of Formula 12 is converted to the acid of Formula 6 by conventional hydrolytic methods. This method is further illustrated in Example 1.

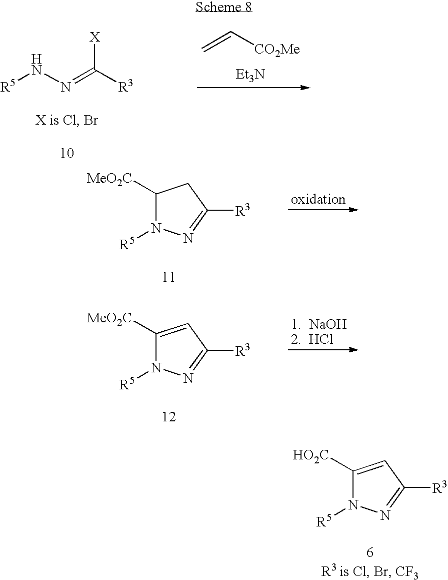

Hydrazonyl halides of Formula 10, where R³ is Cl or Br, are known in the literature. For the preparation of compounds of this type see for example Journal of Organic Chemistry 1972, 37(12), 2005-9 and Journal of Organic Chemistry 1972, 37(3), 386-90. An alternate method is depicted in Scheme 9. Condensation of the hydrazine of Formula 13 with glycolic acid gives the acid of Formula 14. We have found halogenation of the glyoxylic acid derivative of Formula 14 with either N-bromosuccinimide or N-chlorosuccinimide affords good yields of the hydrazonyl halides of Formula 10 directly. This method is further illustrated in Example 1 (Steps A and B). 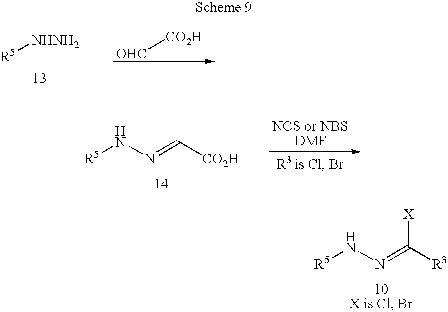
Hydrazonyl halides of Formula 10a (Formula 10 where R³ is CF₃) are also known. Methods for their preparation are shown in Scheme 10. Condensation of the phenylhydrazine of Formula 13 with trifluoroacetaldehyde followed by reaction with either N-bromosuccinimide or N-chlorosuccinimide affords good yields of the hydrazonyl halide of Formula 10a.

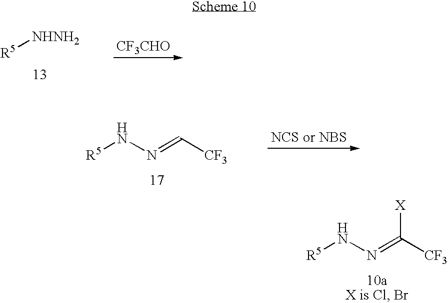

Pyrazole acids of Formula 6, where R³ is OCF₂H and OCH₂CF₃ as well as Cl and Br, can be prepared by the methods outlined in Schemes 11 and 12. Pyrazolones of Formula 18 are prepared in good yield by reaction of a phenylhydrazine of Formula 13 with diethyl maleate. Compounds of Formula 19 where R³ is chloro or bromo can be prepared by reaction of 18 with phosphoryl chloride or phosphoryl bromide, respectively. Compounds of Formula 20 where R³ is OCF₂H or OCH₂CF₃ can be prepared by reaction of pyrazolones of Formula 18 with the appropriate fluoroalkyl halide (R⁸X). 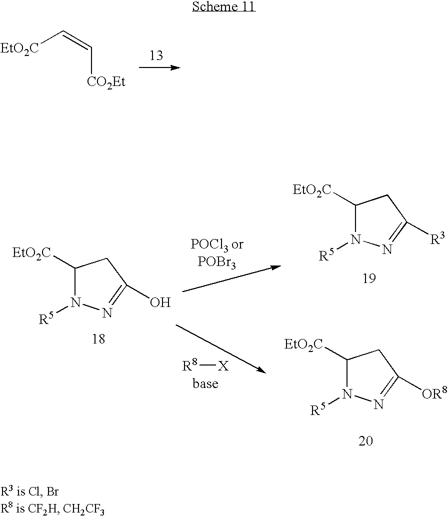
As shown in Scheme 12, oxidation of 19 or 20 followed by hydrolysis of the ester is accomplished as previously described in Scheme 8. The synthetic methods of Schemes 11 and 12 are described in World Patent Application Publication 2003/016283.

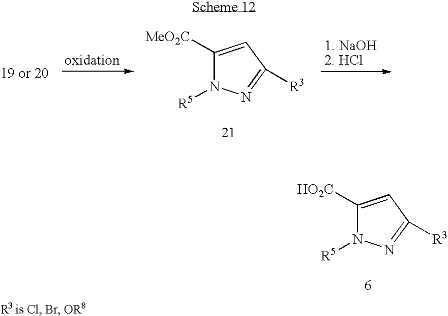

It is recognized that some reagents and reaction conditions described above for preparing compounds of Formula 1 may not be compatible with certain functionalities present in the intermediates. In these instances, the incorporation of protection/deprotection sequences or functional group interconversions into the synthesis will aid in obtaining the desired products. The use and choice of the protecting groups will be apparent to one skilled in chemical synthesis (see, for example, Greene, T. W.; Wuts, P. G. M. Protective Groups in Organic Synthesis, 2nd ed.; Wiley: New York, 1991). One skilled in the art will recognize that, in some cases, after the introduction of a given reagent as it is depicted in any individual scheme, it may be necessary to perform additional routine synthetic steps not described in detail to complete the synthesis of compounds of Formula 1. One skilled in the art will also recognize that it may be necessary to perform a combination of the steps illustrated in the above schemes in an order other than that implied by the particular sequence presented to prepare the compounds of Formula 1.

It is believed that one skilled in the art using the preceding description can utilize the present invention to its fullest extent. The following Examples are, therefore, to be construed as merely illustrative, and not limiting of the disclosure in any way whatsoever. ¹H NMR spectra are reported in ppm downfield from tetramethylsilane; s is singlet, d is doublet, t is triplet, q is quartet, m is multiplet, dd is doublet of doublets, br s is broad singlet.

### EXAMPLE 1

### Preparation of 3-bromo-1-(2-chlorophenyl)-N-[4-cyano-2-methyl-6-[((1-methylethyl)amino)-carbonyl]phenyl]-1H-pyrazol-5-carboxamide

### Step A: Preparation of (2E)-[(2-chlorophenyl)hydrazono]acetic acid

To a solution of 2-chlorophenyl hydrazine hydrochloride (18.8 g, 0.105 mol) in water (300 mL) at room temperature was added concentrated hydrochloric acid (13.2 g, 0.136 mol), followed by dropwise addition over 20 minutes of 50% glyoxylic acid (17.1 g, 0.115 mol) to form a thick precipitate. The reaction mixture was then stirred for 30 minutes. The product was isolated by filtration, washed with water, and then dissolved in ethyl acetate (400 mL). The resulting solution was dried (MgSO₄) and concentrated under reduced pressure to afford the title product as a tan solid (20.5 g).

¹H NMR (Me₂SO-d₆) δ 12.45 (s, 1H), 10.7 (s, 1H), 7.59 (d, 1H), 7.54 (s, 1H), 7.40 (d, 1H), 7.23 (t, 1H), 6.98 (t, 1H).

### Step B: Preparation of (2-chlorophenyl)carbonohydrazonic dibromide

To a solution of the product from Step A (20.5 g, 0.103 mol) in N,N-dimethylformamide (188 mL) at 0° C. was added N-bromosuccinimide (35.7 g, 0.206 mol) portionwise over 30 min. The resulting mixture was stirred overnight at ambient temperature. The reaction mixture was diluted with water (150 mL) and extracted with diethyl ether (3×200 mL). The combined organic extracts were dried (MgSO₄), absorbed onto silica gel and purified by chromatography to afford the title compound as a red oil (12.0 g).

¹H NMR (CDCl₃) δ 8.15 (br d, 1H), 7.41 (d, 1H), 7.31 (d, 1H), 7.21 (d, 1H), 6.90 (d, 1H).

### Step C: Preparation of methyl 3-bromo-1-(2-chlorophenyl)-4,5-dihydro-1H-pyrazole-5-carboxylate

In a solution of the product from Step B (12.0 g, 38.5 mmol) in N,N-dimethylformamide (110 mL) was added methyl acrylate (13.85 mL, 153.8 mmol) in one portion, followed by dropwise addition of N,N-diisopropylethylamine (7.38 mL, 42.3 mmol) over 15 minutes. The reaction mixture was then stirred at ambient temperature for 1 h. The reaction mixture was diluted with water (200 mL) and extracted with diethyl ether (2×200 mL). The combined extracts were washed with water and brine. The ether extracts were dried (MgSO₄) and concentrated under reduced pressure to afford the title compound (12.2 g).

¹H NMR (CDCl₃) δ 7.4 (t, 1H), 7.34 (d, 1H), 7.21 (d, 1H), 7.1 (t, 1H), 5.2 (m, 1H), 3.55 (s, 3H), 3.4 (m,1H).

### Step D: Preparation of methyl 3-bromo-1-(2-chlorophenyl)-1H-pyrazole-5-carboxylate

Into a 1000-mL flask charged with the product from Step C (12.2 g, 38.4 mmol) and acetone (400 mL) was added potassium permanganate (24.2 g, 153.6 mmol) in approximately 1-gram portions every 10 minutes while maintaining the reaction temperature below 40° C. The reaction mixture was then stirred at ambient temperature overnight. The reaction mixture was filtered through Celite® diatomaceous filter aid to remove solids, and then washed with diethyl ether (4×100 mL). After removal of the solvent, the crude product was purified by chromatography on silica gel to afford the title compound as an oil (5.8 g), which solidified on standing.

¹H NMR (CDCl₃) δ 7.5 (d, 1H), 7.4-7.5 (m, 3H), 7.01 (s, 1H), 3.784 (s, 1H).

### Step E: Preparation of 3-bromo-1-(2-chlorophenyl)-1H-pyrazole-5-carboxylic acid

Into a 100 mL flask containing the ester from Step D (5.8 g, 18.4 mmol) in methanol (40 mL) was added 12% aqueous sodium hydroxide (8.8 g, 30.5 mmol). The reaction mixture was stirred at ambient temperature for 2 h. The reaction mixture was then diluted with water (100 mL) and washed with diethyl ether (2×75 mL). The aqueous solution was acidified with concentrated hydrochloric acid to pH 2 and then extracted with ethyl acetate (3×150 mL). The combined ethyl acetate extracts were dried (MgSO₄) and concentrated under reduced pressure to afford the title compound (5.8 g).

¹H NMR (CDCl₃) δ 7.4-7.55 (m, 4H), 7.1 (s, 1H).

### Step F: Preparation of 2-amino-3-methyl-5-iodobenzoic acid

To a solution of 2-amino-3-methylbenzoic acid (5 g, 33 mmol) in N,N-dimethylformamide (30 mL) was added N-iodosuccinimide (7.8 g, 34.7 mmol), and the reaction mixture was heated at 75° C. (oil bath temperature) overnight. After removal of the oil bath, the reaction mixture was then slowly poured into ice-water (100 mL) to precipitate a light grey solid. The solid was filtered and washed with water (4×) and then dried in a vacuum oven at 70° C. The desired intermediate was isolated as a light grey solid (8.8 g).

¹H NMR (Me₂SO-d₆) δ 7.86 (d, 1H), 7.44 (d, 1H), 2.08 (s, 3H).

### Step G: Preparation of 2-amino-3-methyl-5-cyanobenzoic acid

A mixture of 2-amino-3-methyl-5-iodobenzoic acid (17.0 g, 61.3 mmol) and copper cyanide (7.2 g, 78.7 mmol) was heated in N,N-dimethylformamide (200 mL) to 140-145° C. for 20 hours. The reaction mixture was then cooled, and most of the dimethylformamide was removed by concentration on a rotary evaporator at reduced pressure. Water (200 mL) was added to the oily solid followed by ethylenediamine (20 mL), and the mixture was stirred vigorously to dissolve most of the solids. Residual solids were removed by filtration, and concentrated hydrochloric acid was added to the filtrate to adjust the pH to 5. As the pH decreased, some solids precipitated. The resulting mixture was partitioned between ethyl acetate and water. The separated organic solution was dried (MgSO₄), filtered and concentrated under reduced pressure. The residual solids were triturated with a mixture of ether, hexane and ethyl acetate to afford the title compound as a tan solid (7.61 g).

¹H NMR (Me₂SO-d₆) δ 7.97 (s, 1H), 7.50 (s, 1H), 7.3-7.5 (br s, 1H), 2.12 (s, 3H).

### Step H: Preparation of 2-[3-bromo-1-(2-chlorophenyl)-1H-pyrazol-5-yl]-8-methyl-4-oxo-4H-3,1-benzoxazine-6-carbonitrile

To a solution of 3-bromo-1-(2-chlorophenyl)-1H-pyrazole-5-carboxylic acid (i.e. the carboxylic acid product of Step E) (2.0 g, 6.29 mmol) and 2-amino-3-methyl-5-cyanobenzoic acid (i.e. the product of Step G) (1.1 g, 6.29 mmol) in acetonitrile (60 mL) at room temperature was added 3-picoline (3.2 mL, 32.7 mmol). The reaction mixture was stirred for 5 minutes and then cooled to −10° C. Methanesulfonyl chloride (1.3 mL, 16.4 mmol) was then added dropwise, and after completion of the addition the reaction mixture was warmed to room temperature. On stirring overnight at room temperature, the reaction mixture formed a solid precipitate. The solid was isolated by filtration, washed with water, dissolved in excess methylene chloride and dried (MgSO₄). After removal of solvent, the residue was purified by chromatography on silica gel to afford the title compound (1.9 g).

¹H NMR (CDCl₃) δ 8.31 (s, 1H), 7.73 (s,1H), 7.45-7.6 (m, 4H), 7.31 (s,1H), 1.84 (s,1H).

### Step I: Preparation of 3-bromo-1-(2-chlorophenyl)-N-[4-cyano-2-methyl-6-[((1-methylethylamino)carbonyl]phenyl]-1H-pyrazol-5-carboxamide

To a solution of 2-[3-bromo-1-(2-chlorophenyl)-1H-pyrazol-5-yl]-8-methyl-4-oxo-4H-3,1-benzoxazine-6-carbonitrile (i.e. the product of Step H) (2.7 g, 5.7 mmol) in acetonitrile (150 mL) was added dropwise isopropylamine (1.95 mL, 22.9 mmol) and then the reaction was warmed to about 50° C. using a water bath until all solids dissolved. The reaction mixture was stirred at ambient temperature for 2 hours. As the reaction progressed, a thick white solid formed. The solids were isolated by filtration and washed with diethyl ether and hexane to afford the title compound, a compound of the present invention, as a white solid (2.34 g) that melted at 145-149° C.

¹H NMR (CDCl₃) δ 10.5 (br s, 1H), 7.59 (d, 1H), 7.56 (m, 2H), 7.4 (m, 3H), 7.02 (s, 1H), 5.98 (br d, 1H), 4.2 (m, 1H), 2.25 (s, 3H), 1.27 (d, 6H)

### EXAMPLE2

### Preparation of 3-bromo-1-(2-chlorophenyl)-N-[4-cyano-2-methyl-6-[(methylamino)-carbonyl]phenyl]-1H-pyrazol-5-carboxamide

To a solution of 2-[3-bromo-1-(2-chlorophenyl)-1H-pyrazol-5-yl]-8-methyl-4-oxo-4H-3,1-benzoxazine-6-carbonitrile (i.e. the product of Example 1, Step H) (2.7 g, 5.7 mmol) in acetonitrile (150 mL) was added dropwise methylamine (2.0 M solution in THF, 18.0 mL, 36.0 mmol), and the mixture was then stirred at room temperature for 30 minutes. As the reaction progressed, a thick white solid formed. The reaction mixture was cooled to 0° C., and the solids were isolated by filtration and purified by silica gel chromatography to afford the title compound, a compound of the present invention, as a white solid (2.1 g) that melted at 242-243° C.

¹H NMR (CDCl₃) δ 10.45 (br s, 1H), 7.5-7.6 (m, 3H), 7.4 (m, 3H), 7.03 (s, 1H), 6.3 (br d, 1H), 2.98 (d, 3H), 2.25 (s, 3H).

### EXAMPLE 3

### Preparation of 3-bromo-1-(2-chlorophenyl)-N-[2,4-dichloro-6-[(methylamino)-carbonyl]phenyl]-1H-pyrazol-5-carboxamide

### Step A: Preparation of 2-[3-bromo-1-(2-chlorophenyl)-1H-pyrazol-5-yl]-6,8-dichloro-4H-3,1-benzoxazin-4-one

To a mixture of 3-bromo-1-(2-chlorophenyl)-1H-pyrazole-5-carboxylic acid (i.e. the carboxylic acid product of Example 1, Step E) (3.0 g, 9.44 mmol) and 3,5-dichloroanthranilic acid (1.94 g, 9.44 mmol) in acetonitrile (60 mL) was added 3-picoline (4.81 mL, 49.1 mmol) at room temperature, and the reaction mixture was stirred for 5 minutes. The reaction mixture was cooled to −10° C. and methanesulfonyl chloride (1.91 mL, 24.56 mmol) in acetonitrile (5 mL) was added dropwise. The reaction mixture was warmed to room temperature and stirred overnight. The resulting solids were isolated by filtration, washed with water, then dissolved in excess methylene chloride and dried (MgSO₄). The solvent was evaporated under reduced pressure, and the residual solid was purified by chromatography on silica gel to afford the title compound (2.0 g).

¹H NMR (CDCl₃) δ 8.0 (s, 1H), 7.72 (s, 1H), 7.4-7.55 (m, 4H), 7.28 (s, 1H)

### Step B: Preparation of 3-bromo-1-(2-chlorophenyl)-N-[2,4-dichloro-6-[(methylamino)carbonyl]phenyl]-1H-pyrazol-5-carboxamide

To a solution of 2-[3-bromo-1-(2-chlorophenyl)-1H-pyrazol-5-yl]-6,8-dichloro-4H-3,1-benzoxazin-4-one (i.e. the product of Step A) (2.4 g, 8.8 mmol) in acetonitrile (150 mL) cooled to 0° C. was added dropwise methylamine (2.0 M solution in THF, 17.7 mL, 35.4 mmol), and the reaction mixture was stirred for 15 min. As the reaction progressed, a thick white solid formed. The solids were isolated by filtration and purified by silica gel chromatography to afford the title compound, a compound of the present invention, as a white solid (2.08 g), melting at 209-210° C.

¹H NMR (CDCl₃) δ 9.3 (br s, 1H), 7.5 (m, 1H), 7.45 (m, 2H), 3.39 (m, 2H), 7.31 (d, 1H), 7.08 (s, 1H), 6.18 (br d, 1H), 2.91 (d, 1H)

By the procedures described herein together with methods known in the art, the following compounds of Tables 1 to 3 can be prepared. The following abbreviations are used in the Tables which follow: t means tertiary, i means iso, c means cyclo, Me means methyl, Et means ethyl, i-Pr means isopropyl, Bu means butyl, SMe means methylthio, CN means cyano, 2,6-di-Cl means 2,6-dichloro, 2,6-di-F means 2,6-difluoro, 2,4,6-tri-Cl means 2,4,6-trichloro, Yₘ refers to 1 to 3 substituents on the phenyl ring of R⁵ in Formula 1.

TABLE 1

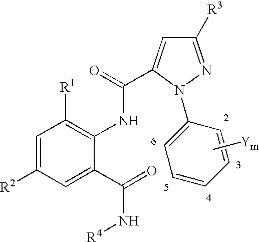

| R¹ | R² | R³ | R⁴ | Yₘ |
|---|---|---|---|---|
| Me | Cl | Cl | Me | 2-Cl |
| Me | Cl | Cl | Et | 2-Cl |
| Me | Cl | Cl | i-Pr | 2-Cl |
| Me | Cl | Cl | t-Bu | 2-Cl |
| Me | Cl | Cl | Me | 2-Br |
| Me | Cl | Cl | Et | 2-Br |
| Me | Cl | Cl | i-Pr | 2-Br |
| Me | Cl | Cl | t-Bu | 2-Br |
| Me | Cl | Cl | Me | 2,6-di-Cl |
| Me | Cl | Cl | Et | 2,6-di-Cl |
| Me | Cl | Cl | i-Pr | 2,6-di-Cl |
| Me | Cl | Cl | t-Bn | 2,6-di-Cl |
| Me | Cl | Cl | Me | 2,6-di-F |
| Me | Cl | Cl | Et | 2,6-di-F |
| Me | Cl | Cl | i-Pr | 2,6-di-F |
| Me | Cl | Cl | t-Bu | 2,6-di-F |
| Me | Cl | Cl | Me | 2,4,6-tri-Cl |
| Me | Cl | Cl | Et | 2,4,6-tri-Cl |
| Me | Cl | Cl | i-Pr | 2,4,6-tri-Cl |
| Me | Cl | Cl | t-Bu | 2,4,6-tri-Cl |
| Me | Cl | Br | Me | 2-Cl |
| Me | Cl | Br | Et | 2-Cl |
| Me | Cl | Br | i-Pr | 2-Cl |
| Me | Cl | Br | t-Bu | 2-Cl |
| Me | Cl | Br | Me | 2-Br |
| Me | Cl | Br | Ef | 2-Br |
| Me | Cl | Br | i-Pr | 2-Br |
| Me | Cl | Br | t-Bu | 2-Br |
| Me | Cl | Br | Me | 2,6-di-Cl |
| Me | Cl | Br | Et | 2,6-di-Cl |
| Me | Cl | Br | i-Pr | 2,6-di-Ci |
| Me | Cl | Br | t-Bu | 2,6-di-Cl |
| Me | Cl | Br | Me | 2,6-di-F |
| Me | Cl | Br | Et | 2,6-di-F |
| Me | Cl | Br | i-Pr | 2,6-di-F |
| Me | Cl | Br | t-Bu | 2,6-di-F |
| Me | Cl | Br | Me | 2,4,6-tri-Cl |
| Me | Cl | Br | Et | 2,4,6-tri-Cl |
| Me | Cl | Br | i-Pr | 2,4,6-tri-Cl |
| Me | Cl | Br | t-Bu | 2,4,6-tri-Cl |
| Me | Cl | CF₃ | Me | 2-Cl |
| Me | Cl | CF₃ | Et | 2-Cl |
| Me | Cl | CF₃ | i-Pr | 2-Cl |
| Me | Cl | CF₃ | t-Bu | 2-Cl |
| Me | Cl | CF₃ | Me | 2-Br |
| Me | Cl | CF₃ | Et | 2-Br |
| Me | Cl | CF₃ | i-Pr | 2-Br |
| Me | Cl | CF₃ | t-Bu | 2-Br |
| Me | Cl | CF₃ | Me | 2,6-di-Cl |
| Me | Cl | CF₃ | Et | 2,6-di-Cl |
| Me | Cl | CF₃ | i-Pr | 2,6-di-CI |
| Me | Cl | CF₃ | t-Bu | 2,6-di-Ci |
| Me | Cl | CF₃ | Me | 2,6-di-F |
| Me | Cl | CF₃ | Et | 2,6-di-F |
| Me | Cl | CF₃ | i-Pr | 2,6-di-F |
| Me | Cl | CF₃ | t-Bu | 2,6-di-F |
| Me | Cl | CF₃ | Me | 2,4,6-tri-Cl |
| Me | Cl | CF₃ | Et | 2,4,6-tri-Cl |
| Me | Cl | CF₃ | i-Pr | 2,4,6-tri-Cl |
| Me | Cl | CF₃ | t-Bu | 2,4,6-tri-Cl |
| Me | Br | Cl | Me | 2-Cl |
| Me | Br | Cl | Et | 2-Cl |
| Me | Br | Cl | i-Pr | 2-Cl |
| Me | Br | Cl | t-Bu | 2-Cl |
| Me | Br | Cl | Me | 2-Br |
| Me | Br | Cl | Et | 2-Br |
| Me | Br | Cl | i-Pr | 2-Br |
| Me | Br | Cl | t-Bu | 2-Br |
| Me | Br | Cl | Me | 2,6-di-Cl |
| Me | Br | Cl | Et | 2,6-di-Cl |
| Me | Br | Cl | i-Pr | 2,6-di-Cl |
| Me | Br | Cl | t-Bu | 2,6-di-Ci |
| Me | Br | Cl | Me | 2,6-di-F |
| Me | Br | Cl | Et | 2,6-di-F |
| Me | Br | Cl | i-Pr | 2,6-di-F |
| Me | Br | Cl | t-Bu | 2,6-di-F |
| Me | Br | Cl | Me | 2,4,6-tri-Cl |
| Me | Br | Cl | Et | 2,4,6-tri-Cl |
| Me | Br | Cl | i-Pr | 2,4,6-tri-Cl |
| Me | Br | Cl | t-Bu | 2,4,6-tri-Cl |
| Me | Br | Br | Me | 2-Cl |
| Me | Br | Br | Et | 2-Cl |
| Me | Br | Br | i-Pr | 2-Cl |
| Me | Br | Br | t-Bu | 2-Cl |
| Me | Br | Br | Me | 2-Br |
| Me | Br | Br | Et | 2-Br |
| Me | Br | Br | i-Pr | 2-Br |
| Me | Br | Br | t-Bu | 2-Br |
| Me | Br | Br | Me | 2,6-di-Ci |
| Me | Br | Br | Et | 2,6-di-Ci |
| Me | Br | Br | i-Pr | 2,6-di-Ci |
| Me | Br | Br | t-Bu | 2,6-di-Ci |
| Me | Br | Br | Me | 2,6-di-F |
| Me | Br | Br | Et | 2,6-di-F |
| Me | Br | Br | i-Pr | 2,6-di-F |
| Me | Br | Br | t-Bu | 2,6-di-F |
| Me | Br | Br | Me | 2,4,6-tri-Cl |
| Me | Br | Br | Et | 2,4,6-tri-Cl |
| Me | Br | Br | i-Pr | 2,4,6-tri-Cl |
| Me | Br | Br | t-Bu | 2,4,6-tri-Cl |
| Me | Br | CF₃ | Me | 2-Cl |
| Me | Br | CF₃ | Et | 2-Cl |
| Me | Br | CF₃ | i-Pr | 2-Cl |
| Me | Br | CF₃ | t-Bu | 2-Cl |
| Me | Br | CF₃ | Me | 2-Br |
| Me | Br | CF₃ | Et | 2-Br |
| Me | Br | CF₃ | i-Pr | 2-Br |
| Me | Br | CF₃ | t-Bu | 2-Br |
| Me | Br | CF₃ | Me | 2,6-di-Ci |
| Me | Br | CF₃ | Et | 2,6-di-Cl |
| Me | Br | CF₃ | i-Pr | 2,6-di-Ci |
| Me | Br | CF₃ | t-Bu | 2,6-di-Cl |
| Me | Br | CF₃ | Me | 2,6-di-F |
| Me | Br | CF₃ | Et | 2,6-di-F |
| Me | Br | CF₃ | i-Pr | 2,6-di-F |
| Me | Br | CF₃ | t-Bu | 2,6-di-F |
| Me | Br | CF₃ | Me | 2,4,6-tri-Cl |
| Me | Br | CF₃ | Et | 2,4,6-tri-Cl |
| Me | Br | CF₃ | i-Pr | 2,4,6-tri-Cl |
| Me | Br | CF₃ | t-Bu | 2,4,6-tri-Cl |
| Me | CN | Cl | Me | 2-Cl |
| Me | CN | Cl | Et | 2-Cl |
| Me | CN | Cl | i-Pr | 2-Cl |
| Me | CN | Cl | t-Bu | 2-Cl |
| Me | CN | Cl | Me | 2-Br |
| Me | CN | Cl | Et | 2-Br |
| Me | CN | Cl | i-Pr | 2-Br |
| Me | CN | Cl | t-Bu | 2-Br |
| Me | CN | Cl | Me | 2,6-di-Ci |
| Me | CN | Cl | Et | 2,6-di-Ci |
| Me | CN | Cl | i-Pr | 2,6-di-Ci |
| Me | CN | Cl | t-Bu | 2,6-di-Ci |
| Me | CN | Cl | Me | 2,6-di-F |
| Me | CN | Cl | Et | 2,6-di-F |
| Me | CN | Cl | i-Pr | 2,6-di-F |
| Me | CN | Cl | t-Bu | 2,6-di-F |
| Me | CN | Cl | Me | 2,4,6-tri-Cl |
| Me | CN | Cl | Et | 2,4,6-tri-Cl |
| Me | CN | Cl | i-Pr | 2,4,6-tri-Cl |
| Me | CN | Cl | t-Bu | 2,4,6-tri-Cl |
| Me | CN | Br | Me | 2-Cl |
| Me | CN | Br | Et | 2-Cl |
| Me | CN | Br | i-Pr | 2-Cl |
| Me | CN | Br | t-Bu | 2-Cl |
| Me | CN | Br | Me | 2-Br |
| Me | CN | Br | Et | 2-Br |
| Me | CN | Br | i-Pr | 2-Br |
| Me | CN | Br | t-Bu | 2-Br |
| Me | CN | Br | Me | 2,6-di-Cl |
| Me | CN | Br | Et | 2,6-di-Ci |
| Me | CN | Br | i-Pr | 2, 6-di-Cl |
| Me | CN | Br | t-Bu | 2,6-di-Cl |
| Me | CN | Br | Me | 2,6-di-F |
| Me | CN | Br | Et | 2,6-di-F |
| Me | CN | Br | i-Pr | 2,6-di-F |
| Me | CN | Br | t-Bu | 2,6-di-F |
| Me | CN | Br | Me | 2,4,6-tri-Cl |
| Me | CN | Br | Et | 2,4,6-tri-Cl |
| Me | CN | Br | i-Pr | 2,4,6-tri-Cl |
| Me | CN | Br | t-Bu | 2,4,6-tri-Cl |
| Me | CN | CF₃ | Me | 2-Cl |
| Me | CN | CF₃ | Et | 2-Cl |
| Me | CN | CF₃ | i-Pr | 2-Cl |
| Me | CN | CF₃ | t-Bu | 2-Cl |
| Me | CN | CF₃ | Me | 2-Br |
| Me | CN | CF₃ | Et | 2-Br |
| Me | CN | CF₃ | i-Pr | 2-Br |
| Me | CN | CF₃ | t-Bu | 2-Br |
| Me | CN | CF₃ | Me | 2,6-di-Ci |
| Me | CN | CF₃ | Et | 2,6-di-Ci |
| Me | CN | CF₃ | i-Pr | 2,6-di-Ci |
| Me | CN | CF₃ | t-Bu | 2,6-di-Ci |
| Me | CN | CF₃ | Me | 2,6-di-F |
| Me | CN | CF₃ | Et | 2,6-di-F |
| Me | CN | CF₃ | i-Pr | 2,6-di-F |
| Me | CN | CF₃ | t-Bu | 2,6-di-F |
| Me | CN | CF₃ | Me | 2,4,6-tri-Cl |
| Me | CN | CF₃ | Et | 2,4,6-tri-Cl |
| Me | CN | CF₃ | i-Pr | 2,4,6-tri-Cl |
| Me | CN | CF₃ | t-Bu | 2,4,6-tri-Cl |
| Br | Cl | Cl | Me | 2-Cl |
| Br | Cl | Cl | Et | 2-Cl |
| Br | Cl | Cl | i-Pr | 2-Cl |
| Br | Cl | Cl | t-Bu | 2-Cl |
| Br | Cl | Cl | Me | 2-Br |
| Br | Cl | Cl | Et | 2-Br |
| Br | Cl | Cl | i-Pr | 2-Br |
| Br | Cl | Cl | t-Bu | 2-Br |
| Br | Cl | Cl | Me | 2,6-di-Cl |
| Br | Cl | Cl | Et | 2,6-di-Cl |
| Br | Cl | Cl | i-Pr | 2,6-di-Cl |
| Br | Cl | Cl | t-Bu | 2,6-di-Cl |
| Br | Cl | Cl | Me | 2,6-di-F |
| Br | Cl | Cl | Et | 2,6-di-F |
| Br | Cl | Cl | i-Pr | 2,6-di-F |
| Br | Cl | Cl | t-Bu | 2,6-di-F |
| Br | Cl | Cl | Me | 2,4,6-tri-Cl |
| Br | Cl | Cl | Et | 2,4,6-tri-Cl |
| Br | Cl | Cl | i-Pr | 2,4,6-tri-Cl |
| Br | Cl | Cl | t-Bu | 2,4,6-tri-Cl |
| Br | Cl | CF₃ | Me | 2-Cl |
| Br | Cl | CF₃ | Et | 2-Cl |
| Br | Cl | CF₃ | i-Pr | 2-Cl |
| Br | Cl | CF₃ | t-Bu | 2-Cl |
| Br | Cl | CF₃ | Me | 2-Br |
| Br | Cl | CF₃ | Et | 2-Br |
| Br | Cl | CF₃ | i-Pr | 2-Br |
| Br | Cl | CF₃ | t-Bu | 2-Br |
| Br | Cl | CF₃ | Me | 2,6-di-Cl |
| Br | Cl | CF₃ | Et | 2,6-di-Ci |
| Br | Cl | CF₃ | i-Pr | 2,6-di-Ci |
| Br | Cl | CF₃ | t-Bu | 2,6-di-Cl |
| Br | Cl | CF₃ | Me | 2,6-di-F |
| Br | Cl | CF₃ | Et | 2,6-di-F |
| Br | Cl | CF₃ | i-Pr | 2,6-di-F |
| Br | Cl | CF₃ | t-Bu | 2,6-di-F |
| Br | Cl | CF₃ | Me | 2,4,6-tri-Cl |
| Br | Cl | CF₃ | Et | 2,4,6-tri-Cl |
| Br | Cl | CF₃ | i-Pr | 2,4,6-tri-Cl |
| Br | Cl | CF₃ | t-Bu | 2,4,6-tri-Cl |
| Br | Br | Br | Me | 2-Cl |
| Br | Br | Br | Et | 2-Cl |
| Br | Br | Br | i-Pr | 2-Cl |
| Br | Br | Br | t-Bu | 2-Cl |
| Br | Br | Br | Me | 2-Br |
| Br | Br | Br | Et | 2-Br |
| Br | Br | Br | i-Pr | 2-Br |
| Br | Br | Br | t-Bu | 2-Br |
| Br | Br | Br | Me | 2,6-di-Cl |
| Br | Br | Br | Et | 2,6-di-Cl |
| Br | Br | Br | i-Pr | 2,6-di-Cl |
| Br | Br | Br | t-Bu | 2,6-di-Cl |
| Br | Br | Br | Me | 2,6-di-F |
| Br | Br | Br | Et | 2,6-di-F |
| Br | Br | Br | i-Pr | 2,6-di-F |
| Br | Br | Br | t-Bu | 2,6-di-F |
| Br | Br | Br | Me | 2,4,6-tri-Cl |
| Br | Br | Br | Et | 2,4,6-tri-Cl |
| Br | Br | Br | i-Pr | 2,4,6-tri-Cl |
| Br | Br | Br | t-Bu | 2,4,6-tri-Cl |
| Br | CN | Cl | Me | 2-Cl |
| Br | CN | Cl | Et | 2-Cl |
| Br | CN | Cl | i-Pr | 2-Cl |
| Br | CN | Cl | t-Bu | 2-Cl |
| Br | CN | Cl | Me | 2-Br |
| Br | CN | Cl | Et | 2-Br |
| Br | CN | Cl | i-Pr | 2-Br |
| Br | CN | Cl | t-Bu | 2-Br |
| Br | CN | Cl | Me | 2,6-di-Ci |
| Br | CN | Cl | Et | 2,6-di-Ci |
| Br | CN | Cl | i-Pr | 2,6-di-Ci |
| Br | CN | Cl | t-Bu | 2,6-di-Ci |
| Br | CN | Cl | Me | 2,6-di-F |
| Br | CN | Cl | Et | 2,6-di-F |
| Br | CN | Cl | i-Pr | 2,6-di-F |
| Br | CN | Cl | t-Bu | 2,6-di-F |
| Br | CN | Cl | Me | 2,4,6-tri-Cl |
| Br | CN | Cl | Et | 2,4,6-tri-Cl |
| Br | CN | Cl | i-Pr | 2,4,6-tri-Cl |
| Br | CN | Cl | t-Bu | 2,4,6-tri-Cl |
| Br | CN | CF₃ | Me | 2-Cl |
| Br | CN | CF₃ | Et | 2-Cl |
| Br | CN | CF₃ | i-Pr | 2-Cl |
| Br | CN | CF₃ | t-Bu | 2-Cl |
| Br | CN | CF₃ | Me | 2-Br |
| Br | CN | CF₃ | Et | 2-Br |
| Br | CN | CF₃ | i-Pr | 2-Br |
| Br | CN | CF₃ | t-Bu | 2-Br |
| Br | CN | CF₃ | Me | 2,6-di-Cl |
| Br | CN | CF₃ | Et | 2,6-di-Cl |
| Me | I | Cl | Me | 2-Cl |
| Me | I | Cl | Et | 2-Cl |
| Me | I | Cl | i-Pr | 2-Cl |
| Me | I | Cl | t-Bu | 2-Cl |
| Me | I | Cl | Me | 2-Br |
| Me | I | Cl | Et | 2-Br |
| Me | I | Cl | i-Pr | 2-Br |
| Me | I | Cl | t-Bu | 2-Br |
| Me | I | Cl | Me | 2,6-di-Ci |
| Me | I | Cl | Et | 2,6-di-Ci |
| Me | I | Cl | i-Pr | 2,6-di-Ci |
| Me | I | Cl | t-Bu | 2,6-di-Ci |
| Me | I | CF₃ | Me | 2-Cl |
| Me | I | CF₃ | Et | 2-Cl |
| Me | I | CF₃ | i-Pr | 2-Cl |
| Me | I | CF₃ | t-Bu | 2-Cl |
| Me | I | CF₃ | Me | 2-Br |
| Me | I | CF₃ | Et | 2-Br |
| Cl | Cl | Cl | Me | 2-Cl |
| Cl | Cl | Cl | Et | 2-Cl |
| Cl | Cl | Cl | i-Pr | 2-Cl |
| Cl | Cl | Cl | t-Bu | 2-Cl |
| Cl | Cl | Cl | Me | 2-Br |
| Cl | Cl | Cl | Et | 2-Br |
| Cl | Cl | Cl | i-Pr | 2-Br |
| Cl | Cl | Cl | t-Bu | 2-Br |
| Cl | Cl | Cl | Me | 2,6-di-Cl |
| Cl | Cl | Cl | Et | 2,6-di-Cl |
| Cl | Cl | Cl | i-Pr | 2,6-di-Cl |
| Cl | Cl | Cl | t-Bu | 2,6-di-Cl |
| Cl | Cl | Cl | Me | 2,6-di-F |
| Cl | Cl | Cl | Et | 2,6-di-F |
| Cl | Cl | Cl | i-Pr | 2,6-di-F |
| Cl | Cl | Cl | t-Bu | 2,6-di-F |
| Cl | Cl | Cl | Me | 2,4,6-tri-Cl |
| Cl | Cl | Cl | Et | 2,4,6-tri-Cl |
| Cl | Cl | Cl | i-Pr | 2,4,6-tri-Cl |
| Cl | Cl | Cl | t-Bu | 2,4,6-tri-Cl |
| Cl | Cl | Br | Me | 2-Cl |
| Cl | Cl | Br | Et | 2-Cl |
| Cl | Cl | Br | i-Pr | 2-Cl |
| Cl | Cl | Br | t-Bu | 2-Cl |
| Cl | Cl | Br | Me | 2-Br |
| Cl | Cl | Br | Et | 2-Br |
| Cl | Cl | Br | i-Pr | 2-Br |
| Cl | Cl | Br | t-Bu | 2-Br |
| Cl | Cl | Br | Me | 2,6-di-Ci |
| Cl | Cl | Br | Et | 2,6-di-Cl |
| Cl | Cl | Br | i-Pr | 2,6-di-Ci |
| Cl | Cl | Br | t-Bu | 2,6-di-Ci |
| Cl | Cl | Br | Me | 2,6-di-F |
| Cl | Cl | Br | Et | 2,6-di-F |
| Cl | Cl | Br | i-Pr | 2,6-di-F |
| Cl | Cl | Br | f-Bu | 2,6-di-F |
| Cl | Cl | Br | Me | 2,4,6-tri-Cl |
| Cl | Cl | Br | Et | 2,4,6-tri-Cl |
| Cl | Cl | Br | i-Pr | 2,4,6-tri-Cl |
| Cl | Cl | Br | t-Bu | 2,4,6-tri-Cl |
| Cl | Cl | CF₃ | Me | 2-Cl |
| Cl | Cl | CF₃ | Et | 2-Cl |
| Cl | Cl | CF₃ | i-Pr | 2-Cl |
| Cl | Cl | CF₃ | t-Bu | 2-Cl |
| Cl | Cl | CF₃ | Me | 2-Br |
| Cl | Cl | CF₃ | Et | 2-Br |
| Cl | Cl | CF₃ | i-Pr | 2-Br |
| Cl | Cl | CF₃ | t-Bu | 2-Br |
| Cl | Cl | CF₃ | Me | 2,6-di-Cl |
| Cl | Cl | CF₃ | Et | 2,6-di-Cl |
| Cl | Cl | CF₃ | i-Pr | 2,6-di-Cl |
| Cl | Cl | CF₃ | t-Bu | 2,6-di-Ci |
| Cl | Cl | CF₃ | Me | 2,6-di-F |
| Cl | Cl | CF₃ | Et | 2,6-di-F |
| Cl | Cl | CF₃ | i-Pr | 2,6-di-F |
| Cl | Cl | CF₃ | t-Bu | 2,6-di-F |
| Cl | Cl | CF₃ | Me | 2,4,6-tri-Cl |
| Cl | Cl | CF₃ | Et | 2,4,6-tri-Cl |
| Cl | Cl | CF₃ | i-Pr | 2,4,6-tri-Cl |
| Cl | Cl | CF₃ | t-Bu | 2,4,6-tri-Cl |
| Cl | Br | Cl | Me | 2-Cl |
| Cl | Br | Cl | Et | 2-Cl |
| Cl | Br | Cl | i-Pr | 2-Cl |
| Cl | Br | Cl | t-Bu | 2-Cl |
| Cl | Br | Cl | Me | 2-Br |
| Cl | Br | Cl | Et | 2-Br |
| Cl | Br | Cl | i-Pr | 2-Br |
| Cl | Br | Cl | t-Bu | 2-Br |
| Cl | Br | Cl | Me | 2,6-di-Cl |
| Cl | Br | Cl | Et | 2,6-di-Ci |
| Cl | Br | Cl | i-Pr | 2,6-di-Cl |
| Cl | Br | Cl | t-Bu | 2,6-di-Ci |
| Cl | Br | Cl | Me | 2,6-di-F |
| Cl | Br | Cl | Et | 2,6-di-F |
| Cl | Br | Cl | i-Pr | 2,6-di-F |
| Cl | Br | Cl | t-Bu | 2,6-di-F |
| Cl | Br | Cl | Me | 2,4,6-tri-Cl |
| Cl | Br | Cl | Et | 2,4,6-tri-Cl |
| Cl | Br | Cl | i-Pr | 2,4,6-tri-Cl |
| Cl | Br | Cl | t-Bu | 2,4,6-tri-Cl |
| Cl | Br | Br | Me | 2-Cl |
| Cl | Br | Br | Et | 2-Cl |
| Cl | Br | Br | i-Pr | 2-Cl |
| Cl | Br | Br | t-Bu | 2-Cl |
| Cl | Br | Br | Me | 2-Br |
| Cl | Br | Br | Et | 2-Br |
| Cl | Br | Br | i-Pr | 2-Br |
| Cl | Br | Br | t-Bu | 2-Br |
| Cl | Br | Br | Me | 2,6-di-Ci |
| Cl | Br | Br | Et | 2,6-di-Ci |
| Cl | Br | Br | i-Pr | 2,6-di-Ci |
| Cl | Br | Br | t-Bu | 2,6-di-Ci |
| Cl | Br | Br | Me | 2,6-di-F |
| Cl | Br | Br | Et | 2,6-di-F |
| Cl | Br | Br | i-Pr | 2,6-di-F |
| Cl | Br | Br | t-Bu | 2,6-di-F |
| Cl | Br | Br | Me | 2,4,6-tri-Cl |
| Cl | Br | Br | Et | 2,4,6-tri-Cl |
| Cl | Br | Br | i-Pr | 2,4,6-tri-Cl |
| Cl | Br | Br | t-Bu | 2,4,6-tri-Cl |
| Cl | Br | CF₃ | Me | 2-Cl |
| Cl | Br | CF₃ | Et | 2-Cl |
| Cl | Br | CF₃ | i-Pr | 2-Cl |
| Cl | Br | CF₃ | t-Bu | 2-Cl |
| Cl | Br | CF₃ | Me | 2-Br |
| Cl | Br | CF₃ | Et | 2-Br |
| Cl | Br | CF₃ | i-Pr | 2-Br |
| Cl | Br | CF₃ | t-Bu | 2-Br |
| Cl | Br | CF₃ | Me | 2,6-di-Cl |
| Cl | Br | CF₃ | Et | 2,6-di-Cl |
| Cl | Br | CF₃ | i-Pr | 2,6-di-Cl |
| Cl | Br | CF₃ | t-Bu | 2,6-di-Cl |
| Cl | Br | CF₃ | Me | 2,6-di-F |
| Cl | Br | CF₃ | Et | 2,6-di-F |
| Cl | Br | CF₃ | i-Pr | 2,6-di-F |
| Cl | Br | CF₃ | t-Bu | 2,6-di-F |
| Cl | Br | CF₃ | Me | 2,4,6-tri-Cl |
| Cl | Br | CF₃ | Et | 2,4,6-tri-Cl |
| Cl | Br | CF₃ | i-Pr | 2,4,6-tri-Cl |
| Cl | Br | CF₃ | t-Bu | 2,4,6-tri-Cl |
| Cl | CN | Cl | Me | 2-Cl |
| Cl | CN | Cl | Et | 2-Cl |
| Cl | CN | Cl | i-Pr | 2-Cl |
| Cl | CN | Cl | t-Bu | 2-Cl |
| Cl | CN | Cl | Me | 2-Br |
| Cl | CN | Cl | Et | 2-Br |
| Cl | CN | Cl | i-Pr | 2-Br |
| Cl | CN | Cl | t-Bu | 2-Br |
| Cl | CN | Cl | Me | 2,6-di-Ci |
| Cl | CN | Cl | Et | 2,6-di-Ci |
| Cl | CN | Cl | i-Pr | 2,6-di-Ci |
| Cl | CN | Cl | t-Bu | 2,6-di-Ci |
| Cl | CN | Cl | Me | 2,6-di-F |
| Cl | CN | Cl | Et | 2,6-di-F |
| Cl | CN | Cl | i-Pr | 2,6-di-F |
| Cl | CN | Cl | t-Bu | 2,6-di-F |
| Cl | CN | Cl | Me | 2,4,6-tri-Cl |
| Cl | CN | Cl | Et | 2,4,6-tri-Cl |
| Cl | CN | Cl | i-Pr | 2,4,6-tri-Cl |
| Cl | CN | Cl | t-Bu | 2,4,6-tri-Cl |
| Cl | CN | Br | Me | 2-Cl |
| Cl | CN | Br | Et | 2-Cl |
| Cl | CN | Br | i-Pr | 2-Cl |
| Cl | CN | Br | t-Bu | 2-Cl |
| Cl | CN | Br | Me | 2-Br |
| Cl | CN | Br | Et | 2-Br |
| Cl | CN | Br | i-Pr | 2-Br |
| Cl | CN | Br | t-Bu | 2-Br |
| Cl | CN | Br | Me | 2,6-di-Cl |
| Cl | CN | Br | Et | 2,6-di-Cl |
| Cl | CN | Br | i-Pr | 2,6-di-Ci |
| Cl | CN | Br | t-Bu | 2,6-di-Ci |
| Cl | CN | Br | Me | 2,6-di-F |
| Cl | CN | Br | Et | 2,6-di-F |
| Cl | CN | Br | i-Pr | 2,6-di-F |
| Cl | CN | Br | t-Bu | 2,6-di-F |
| Cl | CN | Br | Me | 2,4,6-tri-Cl |
| Cl | CN | Br | Et | 2,4,6-tri-Cl |
| Cl | CN | Br | i-Pr | 2,4,6-tri-Cl |
| Cl | CN | Br | t-Bu | 2,4,6-tri-Cl |
| Cl | CN | CF₃ | Me | 2-Cl |
| Cl | CN | CF₃ | Et | 2-Cl |
| Cl | CN | CF₃ | i-Pr | 2-Cl |
| Cl | CN | CF₃ | t-Bu | 2-Cl |
| Cl | CN | CF₃ | Me | 2-Br |
| Cl | CN | CF₃ | Et | 2-Br |
| Cl | CN | CF₃ | i-Pr | 2-Br |
| Cl | CN | CF₃ | t-Bu | 2-Br |
| Cl | CN | CF₃ | Me | 2,6-di-Ci |
| Cl | CN | CF₃ | Et | 2,6-di-Ci |
| Cl | CN | CF₃ | i-Pr | 2,6-di-Ci |
| Cl | CN | CF₃ | t-Bu | 2,6-di-Ci |
| Cl | CN | CF₃ | Me | 2,6-di-F |
| Cl | CN | CF₃ | Et | 2,6-di-F |
| Cl | CN | CF₃ | i-Pr | 2,6-di-F |
| Cl | CN | CF₃ | t-Bu | 2,6-di-F |
| Cl | CN | CF₃ | Me | 2,4,6-tri-Cl |
| Cl | CN | CF₃ | Et | 2,4,6-tri-Cl |
| Cl | CN | CF₃ | i-Pr | 2,4,6-tri-Cl |
| Cl | CN | CF₃ | t-Bu | 2,4,6-tri-Cl |
| Br | Cl | Br | Me | 2-Cl |
| Br | Cl | Br | Et | 2-Cl |
| Br | Cl | Br | i-Pr | 2-Cl |
| Br | Cl | Br | t-Bu | 2-Cl |
| Br | Cl | Br | Me | 2-Br |
| Br | Cl | Br | Et | 2-Br |
| Br | Cl | Br | i-Pr | 2-Br |
| Br | Cl | Br | t-Bu | 2-Br |
| Br | Cl | Br | Me | 2,6-di-Cl |
| Br | Cl | Br | Et | 2,6-di-Cl |
| Br | Cl | Br | i-Pr | 2,6-di-Cl |
| Br | Cl | Br | t-Bu | 2,6-di-Cl |
| Br | Cl | Br | Me | 2,6-di-F |
| Br | Cl | Br | Et | 2,6-di-F |
| Br | Cl | Br | i-Pr | 2,6-di-F |
| Br | Cl | Br | t-Bu | 2,6-di-F |
| Br | Cl | Br | Me | 2,4,6-tri-Cl |
| Br | Cl | Br | Et | 2,4,6-tri-Cl |
| Br | Cl | Br | i-Pr | 2,4,6-tri-Cl |
| Br | Cl | Br | t-Bu | 2,4,6-tri-Cl |
| Br | Br | Cl | Me | 2-Cl |
| Br | Br | Cl | Et | 2-Cl |
| Br | Br | Cl | i-Pr | 2-Cl |
| Br | Br | Cl | t-Bu | 2-Cl |
| Br | Br | Cl | Me | 2-Br |
| Br | Br | Cl | Et | 2-Br |
| Br | Br | Cl | i-Pr | 2-Br |
| Br | Br | Cl | t-Bu | 2-Br |
| Br | Br | Cl | Me | 2,6-di-Ci |
| Br | Br | Cl | Et | 2,6-di-Cl |
| Br | Br | Cl | i-Pr | 2,6-di-Ci |
| Br | Br | Cl | t-Bu | 2,6-di-Ci |
| Br | Br | Cl | Me | 2,6-di-F |
| Br | Br | Cl | Et | 2,6-di-F |
| Br | Br | Cl | i-Pr | 2,6-di-F |
| Br | Br | Cl | t-Bu | 2,6-di-F |
| Br | Br | Cl | Me | 2,4,6-tri-Cl |
| Br | Br | Cl | Et | 2,4,6-tri-Cl |
| Br | Br | Cl | i-Pr | 2,4,6-tri-Cl |
| Br | Br | Cl | t-Bu | 2,4,6-tri-Cl |
| Br | Br | CF₃ | Me | 2-Cl |
| Br | Br | CF₃ | Et | 2-Cl |
| Br | Br | CF₃ | i-Pr | 2-Cl |
| Br | Br | CF₃ | t-Bu | 2-Cl |
| Br | Br | CF₃ | Me | 2-Br |
| Br | Br | CF₃ | Et | 2-Br |
| Br | Br | CF₃ | i-Pr | 2-Br |
| Br | Br | CF₃ | t-Bu | 2-Br |
| Br | Br | CF₃ | Me | 2,6-di-Cl |
| Br | Br | CF₃ | Et | 2,6-di-Ci |
| Br | Br | CF₃ | i-Pr | 2,6-di-Cl |
| Br | Br | CF₃ | t-Bu | 2,6-di-Cl |
| Br | Br | CF₃ | Me | 2,6-di-F |
| Br | Br | CF₃ | Et | 2,6-di-F |
| Br | Br | CF₃ | i-Pr | 2,6-di-F |
| Br | Br | CF₃ | t-Bu | 2,6-di-F |
| Br | Br | CF₃ | Me | 2,4,6-tri-Cl |
| Br | Br | CF₃ | Et | 2,4,6-tri-Cl |
| Br | Br | CF₃ | i-Pr | 2,4,6-tri-Cl |
| Br | Br | CF₃ | t-Bu | 2,4,6-tri-Cl |
| Br | CN | Br | Me | 2-Cl |
| Br | CN | Br | Et | 2-Cl |
| Br | CN | Br | i-Pr | 2-Cl |
| Br | CN | Br | t-Bu | 2-Cl |
| Br | CN | Br | Me | 2-Br |
| Br | CN | Br | Et | 2-Br |
| Br | CN | Br | i-Pr | 2-Br |
| Br | CN | Br | t-Bu | 2-Br |
| Br | CN | Br | Me | 2,6-di-Cl |
| Br | CN | Br | Et | 2,6-di-Cl |
| Br | CN | Br | i-Pr | 2,6-di-Cl |
| Br | CN | Br | t-Bu | 2,6-di-Cl |
| Br | CN | Br | Me | 2,6-di-F |
| Br | CN | Br | Et | 2,6-di-F |
| Br | CN | Br | i-Pr | 2,6-di-F |
| Br | CN | Br | t-Bu | 2,6-di-F |
| Br | CN | Br | Me | 2,4,6-tri-Cl |
| Br | CN | Br | Et | 2,4,6-tri-Cl |
| Br | CN | Br | i-Pr | 2,4,6-tri-Cl |
| Br | CN | Br | t-Bu | 2,4,6-tri-Cl |
| Br | CN | CF₃ | i-Pr | 2,6-di-Cl |
| Br | CN | CF₃ | t-Bu | 2,6-di-Cl |
| Br | CN | CF₃ | Me | 2,6-di-F |
| Br | CN | CF₃ | Et | 2,6-di-F |
| Br | CN | CF₃ | i-Pr | 2,6-di-F |
| Br | CN | CF₃ | t-Bu | 2,6-di-F |
| Br | CN | CF₃ | Me | 2,4,6-tri-Cl |
| Br | CN | CF₃ | Et | 2,4,6-tri-Cl |
| Br | CN | CF₃ | i-Pr | 2,4,6-tri-Cl |
| Br | CN | CF₃ | t-Bu | 2,4,6-tri-Cl |
| Me | I | Br | Me | 2-Cl |
| Me | I | Br | Et | 2-Cl |
| Me | I | Br | i-Pr | 2-Cl |
| Me | I | Br | t-Bu | 2-Cl |
| Me | I | Br | Me | 2-Br |
| Me | I | Br | Et | 2-Br |
| Me | I | Br | i-Pr | 2-Br |
| Me | I | Br | t-Bu | 2-Br |
| Me | I | Br | Me | 2,6-di-Ci |
| Me | I | Br | Et | 2,6-di-Ci |
| Me | I | Br | i-Pr | 2,6-di-Ci |
| Me | I | Br | t-Bu | 2,6-di-Ci |
| Me | I | CF₃ | i-Pr | 2-Br |
| Me | I | CF₃ | t-Bu | 2-Br |
| Me | I | CF₃ | Me | 2,6-di-Cl |
| Me | I | CF₃ | Et | 2,6-di-Ci |
| Me | I | CF₃ | i-Pr | 2,6-di-Cl |
| Me | I | CF₃ | t-Bu | 2,6-di-Cl |

TABLE 2

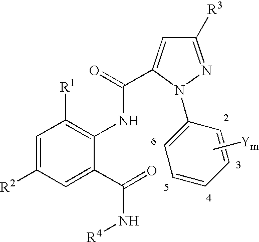

| R¹ | R² | R³ | R⁴ | Yₘ |
|---|---|---|---|---|
| Me | Cl | OCF₂H | Me | 2-Cl |
| Me | Cl | OCF₂H | Et | 2-Cl |
| Me | Cl | OCF₂H | i-Pr | 2-Cl |
| Me | Cl | OCF₂H | t-Bu | 2-Cl |
| Me | Cl | OCF₂H | Me | 2-Br |
| Me | Cl | OCF₂H | Et | 2-Br |
| Me | Cl | OCF₂H | i-Pr | 2-Br |
| Me | Cl | OCF₂H | t-Bu | 2-Br |
| Me | Cl | OCF₂H | Me | 2,6-di-Cl |
| Me | Cl | OCF₂H | Et | 2,6-di-Cl |
| Me | Cl | OCF₂H | i-Pr | 2,6-di-Cl |
| Me | Cl | OCF₂H | t-Bu | 2,6-di-Cl |
| Me | CN | OCF₂H | Me | 2-Cl |
| Me | CN | OCF₂H | Et | 2-Cl |
| Me | CN | OCF₂H | i-Pr | 2-Cl |
| Me | CN | OCF₂H | t-Bu | 2-Cl |
| Me | CN | OCF₂H | Me | 2-Br |
| Me | CN | OCF₂H | Et | 2-Br |
| Me | CN | OCF₂H | i-Pr | 2-Br |
| Me | CN | OCF₂H | t-Bu | 2-Br |
| Me | CN | OCF₂H | Me | 2,6-di-Cl |
| Me | CN | OCF₂H | Et | 2,6-di-Cl |
| Me | CN | OCF₂H | i-Pr | 2,6-di-Cl |
| Me | CN | OCF₂H | t-Bu | 2,6-di-Cl |
| Cl | Cl | OCF₂H | Me | 2-Cl |
| Cl | Cl | OCF₂H | Et | 2-Cl |
| Cl | Cl | OCF₂H | i-Pr | 2-Cl |
| Cl | Cl | OCF₂H | t-Bu | 2-Cl |
| Cl | Cl | OCF₂H | Me | 2-Br |
| Cl | Cl | OCF₂H | Et | 2-Br |
| Cl | Cl | OCF₂H | i-Pr | 2-Br |
| Cl | Cl | OCF₂H | t-Bu | 2-Br |
| Cl | Cl | OCF₂H | Me | 2,6-di-Cl |
| Cl | Cl | OCF₂H | Et | 2,6-di-Cl |
| Cl | Cl | OCF₂H | i-Pr | 2,6-di-Cl |
| Cl | Cl | OCF₂H | t-Bu | 2,6-di-Cl |
| Me | Cl | OCH₂CF₃ | Me | 2-Cl |
| Me | Cl | OCH₂CF₃ | Et | 2-Cl |
| Me | Cl | OCH₂CF₃ | i-Pr | 2-Cl |
| Me | Cl | OCH₂CF₃ | t-Bu | 2-Cl |
| Me | Cl | OCH₂CF₃ | Me | 2-Br |
| Me | Cl | OCH₂CF₃ | Et | 2-Br |
| Me | Cl | OCH₂CF₃ | i-Pr | 2-Br |
| Me | Cl | OCH₂CF₃ | t-Bu | 2-Br |
| Me | Cl | OCH₂CF₃ | Me | 2,6-di-Cl |
| Me | Cl | OCH₂CF₃ | Et | 2,6-di-Cl |
| Me | Cl | OCH₂CF₃ | i-Pr | 2,6-di-Cl |
| Me | Cl | OCH₂CF₃ | t-Bu | 2,6-DiCl |
| Me | CN | OCH₂CF₃ | Me | 2-Cl |
| Me | CN | OCH₂CF₃ | Et | 2-Cl |
| Me | CN | OCH₂CF₃ | i-Pr | 2-Cl |
| Me | CN | OCH₂CF₃ | t-Bu | 2-Cl |
| Me | CN | OCH₂CF₃ | Me | 2-Br |
| Me | CN | OCH₂CF₃ | Et | 2-Br |
| Me | CN | OCH₂CF₃ | i-Pr | 2-Br |
| Me | CN | OCH₂CF₃ | t-Bu | 2-Br |
| Me | CN | OCH₂CF₃ | Me | 2,6-di-Cl |
| Me | CN | OCH₂CF₃ | Et | 2,6-di-Cl |
| Me | CN | OCH₂CF₃ | i-Pr | 2,6-di-Cl |
| Me | CN | OCH₂CF₃ | t-Bu | 2,6-di-Cl |
| Cl | Cl | OCH₂CF₃ | Me | 2-Cl |
| Cl | Cl | OCH₂CF₃ | Et | 2-Cl |
| Cl | Cl | OCH₂CF₃ | i-Pr | 2-Cl |
| Cl | Cl | OCH₂CF₃ | t-Bu | 2-Cl |
| Cl | Cl | OCH₂CF₃ | Me | 2-Br |
| Cl | Cl | OCH₂CF₃ | Et | 2-Br |
| Cl | Cl | OCH₂CF₃ | i-Pr | 2-Br |
| Cl | Cl | OCH₂CF₃ | t-Bu | 2-Br |
| Cl | Cl | OCH₂CF₃ | Me | 2,6-di-Cl |
| Cl | Cl | OCH₂CF₃ | Et | 2,6-di-Cl |
| Cl | Cl | OCH₂CF₃ | i-Pr | 2,6-di-Cl |
| Cl | Cl | OCH₂CF₃ | t-Bu | 2,6-di-Cl |

TABLE 3

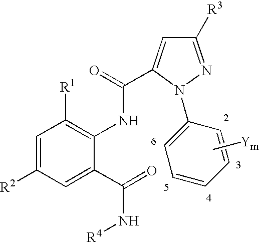

| R¹ | R² | R³ | R⁴ | Yₘ |
|---|---|---|---|---|
| Me | Cl | Cl | H | 2-Cl |
| Me | Cl | Cl | propargyl | 2-Cl |
| Me | Cl | Cl | allyl | 2-Cl |
| Me | Cl | Cl | CH₂CN | 2-Cl |
| Me | Cl | Cl | CH(Me)CH₂SMe | 2-Cl |
| Me | Cl | Cl | C(Me)₂CH₂SMe | 2-Cl |
| Me | Cl | Br | H | 2-Cl |
| Me | Cl | Br | propargyl | 2-Cl |
| Me | Cl | Br | allyl | 2-Cl |
| Me | Cl | Br | CH₂CN | 2-Cl |
| Me | Cl | Br | CH(Me)CH₂SMe | 2-Cl |
| Me | Cl | Br | C(Me)₂CH₂SMe | 2-Cl |
| Me | Cl | CF₃ | H | 2-Cl |
| Me | Cl | CF₃ | propargyl | 2-Cl |
| Me | Cl | CF₃ | allyl | 2-Cl |
| Me | Cl | CF₃ | CH₂CN | 2-Cl |
| Me | Cl | CF₃ | CH(Me)CH₂SMe | 2-Cl |
| Me | Cl | CF₃ | C(Me)₂CH₂SMe | 2-Cl |
| Me | CN | Cl | H | 2-Cl |
| Me | CN | Cl | propargyl | 2-Cl |
| Me | CN | Cl | allyl | 2-Cl |
| Me | CN | Cl | CH₂CN | 2-Cl |
| Me | CN | Cl | CH(Me)CH₂SMe | 2-Cl |
| Me | CN | Cl | C(Me)₂CH₂SMe | 2-Cl |
| Me | CN | Br | H | 2-Cl |
| Me | CN | Br | propargyl | 2-Cl |
| Me | CN | Br | allyl | 2-Cl |
| Me | CN | Br | CH₂CN | 2-Cl |
| Me | CN | Br | CH(Me)CH₂SMe | 2-Cl |
| Me | CN | Br | C(Me)₂CH₂SMe | 2-Cl |
| Me | CN | CF₃ | H | 2-Cl |
| Me | CN | CF₃ | propargyl | 2-Cl |
| Me | CN | CF₃ | allyl | 2-Cl |
| Me | CN | CF₃ | CH₂CN | 2-Cl |
| Me | CN | CF₃ | CH(Me)CH₂SMe | 2-Cl |
| Me | CN | CF₃ | C(Me)₂CH₂SMe | 2-Cl |
| Cl | Cl | Cl | H | 2-Cl |
| Cl | Cl | Cl | propargyl | 2-Cl |
| Cl | Cl | Cl | allyl | 2-Cl |
| Cl | Cl | Cl | CH₂CN | 2-Cl |
| Cl | Cl | Cl | CH(Me)CH₂SMe | 2-Cl |
| Cl | Cl | Cl | C(Me)₂CH₂SMe | 2-Cl |
| Cl | Cl | Br | H | 2-Cl |
| Cl | Cl | Br | propargyl | 2-Cl |
| Cl | Cl | Br | allyl | 2-Cl |
| Cl | Cl | Br | CH₂CN | 2-Cl |
| Cl | Cl | Br | CH(Me)CH₂SMe | 2-Cl |
| Cl | Cl | Br | C(Me)₂CH₂SMe | 2-Cl |
| Cl | Cl | CF₃ | H | 2-Cl |
| Cl | Cl | CF₃ | propargyl | 2-Cl |
| Cl | Cl | CF₃ | allyl | 2-Cl |
| Cl | Cl | CF₃ | CH₂CN | 2-Cl |
| Cl | Cl | CF₃ | CH(Me)CH₂SMe | 2-Cl |
| Cl | Cl | CF₃ | C(Me)₂CH₂SMe | 2-Cl |
| Me | Cl | Cl | H | 2,6-di-Cl |
| Me | Cl | Cl | propargyl | 2,6-di-Cl |
| Me | Cl | Cl | allyl | 2,6-di-Cl |
| Me | Cl | Cl | CH₂CN | 2,6-di-Cl |
| Me | Cl | Cl | CH(Me)CH₂SMe | 2,6-di-Cl |
| Me | Cl | Cl | C(Me)₂CH₂SMe | 2,6-di-Cl |
| Me | Cl | Br | H | 2,6-di-Cl |
| Me | Cl | Br | propargyl | 2,6-di-Cl |
| Me | Cl | Br | allyl | 2,6-di-Cl |
| Me | Cl | Br | CH₂CN | 2,6-di-Cl |
| Me | Cl | Br | CH(Me)CH₂SMe | 2,6-di-Cl |
| Me | Cl | CF₃ | C(Me)₂CH₂SMe | 2,6-di-Cl |
| Me | Cl | CF₃ | H | 2,6-di-Cl |
| Me | Cl | CF₃ | propargyl | 2,6-di-Cl |
| Me | Cl | CF₃ | allyl | 2,6-di-Cl |
| Me | Cl | CF₃ | CH₂CN | 2,6-di-Cl |
| Me | Cl | CF₃ | CH(Me)CH₂SMe | 2,6-di-Cl |
| Me | CN | Cl | C(Me)₂CH₂SMe | 2,6-di-Cl |
| Me | CN | Cl | H | 2,6-di-Cl |
| Me | CN | Cl | propargyl | 2,6-di-Cl |
| Me | CN | Cl | allyl | 2,6-di-Cl |
| Me | CN | Cl | CH₂CN | 2,6-di-Cl |
| Me | CN | Cl | CH(Me)CH₂SMe | 2,6-di-Cl |
| Me | CN | Cl | C(Me)₂CH₂SMe | 2,6-di-Cl |
| Me | CN | Br | H | 2,6-di-Cl |
| Me | CN | Br | propargyl | 2,6-di-Cl |
| Me | CN | Br | allyl | 2,6-di-Cl |
| Me | CN | Br | CH₂CN | 2,6-di-Cl |
| Me | CN | Br | CH(Me)CH₂SMe | 2,6-di-Cl |
| Me | CN | Br | C(Me)₂CH₂SMe | 2,6-di-Cl |
| Me | CN | CF₃ | H | 2,6-di-Cl |
| Me | CN | CF₃ | propargyl | 2,6-di-Cl |
| Me | CN | CF₃ | allyl | 2,6-di-Cl |
| Me | CN | CF₃ | CH₂CN | 2,6-di-Cl |
| Me | CN | CF₃ | CH(Me)CH₂SMe | 2,6-di-Cl |
| Me | CN | CF₃ | C(Me)₂CH₂SMe | 2,6-di-Cl |
| Cl | Cl | Cl | H | 2,6-di-Cl |
| Cl | Cl | Cl | propargyl | 2,6-di-Cl |
| Cl | Cl | Cl | allyl | 2,6-di-Cl |
| Cl | Cl | Cl | CH₂CN | 2,6-di-Cl |
| Cl | Cl | Cl | CH(Me)CH₂SMe | 2,6-di-Cl |
| Cl | Cl | Cl | C(Me)₂CH₂SMe | 2,6-di-Cl |
| Cl | Cl | Br | H | 2,6-di-Cl |
| Cl | Cl | Br | propargyl | 2,6-di-Cl |
| Cl | Cl | Br | allyl | 2,6-di-Cl |
| Cl | Cl | Br | CH₂CN | 2,6-di-Cl |
| Cl | Cl | Br | CH(Me)CH₂SMe | 2,6-di-Cl |
| Cl | Cl | CF₃ | C(Me)₂CH₂SMe | 2,6-di-Cl |
| Cl | Cl | CF₃ | H | 2,6-di-Cl |
| Cl | Cl | CF₃ | propargyl | 2,6-di-Cl |
| Cl | Cl | CF₃ | allyl | 2,6-di-Cl |
| Cl | Cl | CF₃ | CH₂CN | 2,6-di-Cl |
| Cl | Cl | CF₃ | CH(Me)CH₂SMe | 2,6-di-Cl |
| Cl | CN | Cl | C(Me)₂CH₂SMe | 2,6-di-Cl |

Formulation/Utility

Compounds of this invention will generally be used as a formulation or composition with a carrier suitable for agronomic or nonagronomic use comprising at least one of a liquid diluent, a solid diluent or a surfactant. The formulation or composition ingredients are selected to be consistent with the physical properties of the active ingredient, mode of application and environmental factors such as soil type, moisture and temperature. Useful formulations include liquids such as solutions (including emulsifiable concentrates), suspensions, emulsions (including microemulsions and/or suspoemulsions) and the like which optionally can be thickened into gels. Useful formulations further include solids such as dusts, powders, granules, pellets, tablets, films, and the like which can be water-dispersible (“wettable”) or water-soluble. Active ingredient can be (micro)encapsulated and further formed into a suspension or solid formulation; alternatively the entire formulation of active ingredient can be encapsulated (or “overcoated”). Encapsulation can control or delay release of the active ingredient. Sprayable formulations can be extended in suitable media and used at spray volumes from about one to several hundred liters per hectare. High-strength compositions are primarily used as intermediates for further formulation.

The formulations will typically include effective amounts of active ingredient, and at least one of a liquid diluent, a solid diluent, or a surfactant within the following approximate ranges that add up to 100 percent by weight.

| | Weight Percent | | |
|---|---|---|---|
| | Active | | |
| | Ingredient | Diluent | Surfactant |
| Water-Dispersible and Water- | 5-90 | 0-94 | 1-15 |
| soluble Granules, Tablets and | | | |
| Powders. | | | |
| Suspensions, Emulsions, | 5-50 | 40-95 | 0-15 |
| Solutions (including Emulsifiable | | | |
| Concentrates) | | | |
| Dusts | 1-25 | 70-99 | 0-5 |
| Granules and Pellets | 0.01-99 | 5-99.99 | 0-15 |
| High Strength Compositions | 90-99 | 0-10 | 0-2 |

Typical solid diluents are described in Watkins, et al., Handbook of Insecticide Dust Diluents and Carriers, 2nd Ed., Dorland Books, Caldwell, N.J. Typical liquid diluents are described in Marsden, Solvents Guide, 2nd Ed., Interscience, New York, 1950. McCutcheon's Detergents and Emulsifiers Annual, Allured Publ. Corp., Ridgewood, N.J., as well as Sisely and Wood, Encyclopedia of Surface Active Agents, Chemical Publ. Co., Inc., New York, 1964, list surfactants and recommended uses. All formulations can contain minor amounts of additives to reduce foam, caking, corrosion, microbiological growth and the like, or thickeners to increase viscosity.

Surfactants include, for example, polyethoxylated alcohols, polyethoxylated alkylphenols, polyethoxylated sorbitan fatty acid esters, dialkyl sulfosuccinates, alkyl sulfates, alkylbenzene sulfonates, organosilicones, N,N-dialkyltaurates, lignin sulfonates, naphthalene sulfonate formaldehyde condensates, polycarboxylates, and polyoxyethylene/polyoxypropylene block copolymers. Solid diluents include, for example, clays such as bentonite, montmorillonite, attapulgite and kaolin, starch, sugar, silica, talc, diatomaceous earth, urea, calcium carbonate, sodium carbonate and bicarbonate, and sodium sulfate. Liquid diluents include, for example, water, N,N-dimethylformamide, dimethyl sulfoxide, N-alkylpyrrolidone, ethylene glycol, polypropylene glycol, paraffins, alkylbenzenes, alkylnaphthalenes, oils of olive, castor, linseed, tung, sesame, corn, peanut, cotton-seed, soybean, rape-seed and coconut, fatty acid esters, ketones such as cyclohexanone, 2-heptanone, isophorone and 4-hydroxy-4-methyl-2-pentanone, and alcohols such as methanol, cyclohexanol, decanol and tetrahydrofurfuryl alcohol.

Useful formulations of this invention can also include materials known as formulation aids like antifoams, film formers and dyes and are well known to those skilled in the art.

Antifoams can include water dispersible liquids comprising polyorganosiloxanes like Rhodorsil® 415. The film formers can include polyvinyl acetates, polyvinyl acetate copolymers, polyvinylpyrrolidone-vinyl acetate copolymer, polyvinyl alcohols, polyvinyl alcohol copolymers and waxes. Dyes can include water dispersible liquid colorant composition s like Pro-Ized® Colorant Red. One skilled in the art will appreciate that his is a non-exhaustive list of formulation aids. Suitable examples of formulation aids include those listed herein and those listed in McCutcheon's 2001, Volume 2: Functional Materials, published by MC Publishing Company and PCT Publication WO 03/024222.

Solutions, including emulsifiable concentrates, can be prepared by simply mixing the ingredients. Dusts and powders can be prepared by blending and, usually, grinding as in a hammer mill or fluid-energy mill. Suspensions are usually prepared by wet-milling; see, for example, U.S. Pat. No. 3,060,084. Granules and pellets can be prepared by spraying the active material upon preformed granular carriers or by agglomeration techniques. See Browning, “Agglomeration”, Chemical Engineering, Dec. 4, 1967, pp 147-48, Perry's Chemical Engineer's Handbook, 4th Ed., McGraw-Hill, New York, 1963, pages 8-57 and following, and PCT Publication WO 91/13546. Pellets can be prepared as described in U.S. Pat. No. 4,172,714. Water-dispersible and water-soluble granules can be prepared as taught in U.S. Pat. No. 4,144,050, U.S. Pat. No. 3,920,442 and DE 3,246,493. Tablets can be prepared as taught in U.S. Pat. No. 5,180,587, U.S. Pat. No. 5,232,701 and U.S. Pat. No. 5,208,030. Films can be prepared as taught in GB 2,095,558 and U.S. Pat. No. 3,299,566.

For further information regarding the art of formulation, see T. S. Woods, “The Formulator's Toolbox—Product Forms for Modern Agriculture” in Pesticide Chemistry and Bioscience, The Food-Environment Challenge, T. Brooks and T. R. Roberts, Eds., Proceedings of the 9th International Congress on Pesticide Chemistry, The Royal Society of Chemistry, Cambridge, 1999, pp. 120-133. See also U.S. Pat. No. 3,235,361, Col. 6, line 16 through Col. 7, line 19 and Examples 10-41; U.S. Pat. No. 3,309,192, Col. 5, line 43 through Col. 7, line 62 and Examples 8, 12, 15, 39, 41, 52, 53, 58, 132, 138-140, 162-164, 166, 167 and 169-182; U.S. Pat. No. 2,891,855, Col. 3, line 66 through Col. 5, line 17 and Examples 1-4; Klingman, Weed Control as a Science, John Wiley and Sons, Inc., New York, 1961, pp 81-96; Hance et al., Weed Control Handbook, 8th Ed., Blackwell Scientific Publications, Oxford, 1989; Developments in formulation technology, PJB Publications, Richmond, UK, 2000.

In the following Examples, all percentages are by weight and all formulations are prepared in conventional ways. Compound numbers refer to compounds in Index Table A.

### EXAMPLE A

Wettable Powder

| | |
|---|---|
| Compound 1 | 65.0% |
| dodecylphenol polyethylene glycol ether | 2.0% |
| sodium ligninsulfonate | 4.0% |
| sodium silicoaluminate | 6.0% |
| montmorillonite (calcined) | 23.0%. |

### EXAMPLE B

Granule

| | |
|---|---|
| Compound 1 | 10.0% |
| attapulgite granules (low volatile matter, | 90.0%. |
| 0.71/0.30 mm; U.S.S. No. 25-50 sieves) | |

### EXAMPLE C

Extruded Pellet

| | |
|---|---|
| Compound 1 | 25.0% |
| anhydrous sodium sulfate | 10.0% |
| crude calcium ligninsulfonate | 5.0% |
| sodium alkylnaphthalenesulfonate | 1.0% |
| calcium/magnesium bentonite | 59.0%. |

### EXAMPLE D

Emulsifiable Concentrate

| | |
|---|---|
| Compound 1 | 20.0% |
| blend of oil soluble sulfonates | 10.0% |
| and polyoxyethylene ethers | |
| isophorone | 70.0%. |

### EXAMPLE E

Granule

| | |
|---|---|
| Compound 1 | 0.5% |
| cellulose | 2.5% |
| lactose | 4.0% |
| cornmeal | 93.0%. |

Compounds of this invention are characterized by favorable metabolic and/or soil residual patterns and exhibit activity controlling a spectrum of agronomic and non-agronomic invertebrate pests. Compounds of this invention are also characterized by favorable foliar and or soil-applied systemicity in plants exhibiting translocation to protect foliage and other plant parts not directly contacted with insecticidal compositions comprising the present compounds. (In the context of this disclosure “invertebrate pest control” means inhibition of invertebrate pest development (including mortality) that causes significant reduction in feeding or other injury or damage caused by the pest; related expressions are defined analogously.) As referred to in this disclosure, the term “invertebrate pest” includes arthropods, gastropods and nematodes of economic importance as pests. The term “arthropod” includes insects, mites, spiders, scorpions, centipedes, millipedes, pill bugs and symphylans. The term “gastropod” includes snails, slugs and other Stylommatophora. The term “nematode” includes all of the helminths, such as: roundworms, heartworms, and phytophagous nematodes (Nematoda), flukes (Trematoda), Acanthocephala, and tapeworms (Cestoda). Those skilled in the art will recognize that not all compounds are equally effective against all pests. Compounds of this invention display activity against economically important agronomic and nonagronomic pests. The term “agronomic” refers to the production of field crops such as for food and fiber and includes the growth of cereal crops (e.g., wheat, oats, barley, rye, rice, maize), soybeans, vegetable crops (e.g., lettuce, cabbage, tomatoes, beans), potatoes, sweet potatoes, grapes, cotton, and tree fruits (e.g., pome fruits, stone fruits and citrus fruits). The term “nonagronomic” refers to other horticultural (e.g., forest, greenhouse, nursery or ornamental plants not grown in a field), public (human) and animal health (pets, livestock, poultry, nondomesticated animals such as nature animals) by controlling of disease vector pests such as lice, ticks and mosquitoes, domestic and commercial structure, household, and stored product applications or pests. For reason of invertebrate pest control spectrum and economic importance, protection (from damage or injury caused by invertebrate pests) of agronomic crops of cotton, maize, soybeans, rice, vegetable crops, potato, sweet potato, grapes and tree fruit by controlling invertebrate pests are one embodiment of the invention. Agronomic or nonagronomic pests include larvae of the order Lepidoptera, such as armyworms, cutworms, loopers, and heliothines in the family Noctuidae (e.g., fall armyworm (Spodoptera fugiperda J. E. Smith), beet armyworm (Spodoptera exigua Hübner), black cutworm (Agrotis ipsilon Hufnagel), cabbage looper (Trichoplusia ni Hübner), tobacco budworm (Heliotliis virescens Fabricius)); borers, casebearers, webworms, coneworms, cabbageworms and skeletonizers from the family Pyralidae (e.g., European corn borer (Ostrinia nubilalis Hübner), navel orangeworm (Amyelois transitella Walker), corn root webworm (Crambus caliginosellus Clemens), sod webworm (Herpetogramma licarsisalis Walker)); leafrollers, budworms, seed worms, and fruit worms in the family Tortricidae (e.g., codling moth (Cydia pomnonella Linnaeus), grape berry moth (Eindopiza viteana Clemens), oriental fruit moth (Grapholita molesta Busck)); and many other economically important lepidoptera (e.g., diamondback moth (Plutella xylostella Linnaeus), pink bollworm (Pectinophora gossypiella Saunders), gypsy moth (Lymantria dispar Linnaeus)); nymphs and adults of the order Blattodea including cockroaches from the families Blattellidae and Blattidae (e.g., oriental cockroach (Blatta orientalis Linnaeus), Asian cockroach (Blatella asahinai Mizukabo), German cockroach (Blattella germanica Linnaeus), brownbanded cockroach (Supella longipalpa Fabricius), American cockroach (Periplaneta americana Linnaeus), brown cockroach (Periplaneta brunnea Burmeister), Madeira cockroach (Leucophaea maderae Fabricius)); foliar feeding larvae and adults of the order Coleoptera including weevils from the families Anthribidae, Bruchidae, and Curculionidae (e.g., boll weevil (Anthonomus grandis Boheman), rice water weevil (Lissorhoptrus oryzophilus Kuschel), granary weevil (Sitophilus granarius Linnaeus), rice weevil (Sitophilus oryzae Linnaeus)); flea beetles, cucumber beetles, rootworms, leaf beetles, potato beetles, and leafminers in the family Chrysomelidae (e.g., Colorado potato beetle (Leptinotarsa decemlineata Say), western corn rootworm (Diabrotica virgifera virgifera LeConte)); chafers and other beetles from the family Scaribaeidae (e.g., Japanese beetle (Popillia japonica Newman) and European chafer (Rhizotrogus majalis Razoumowsky)); carpet beetles from the family Dermestidae; wireworms from the family Elateridae; bark beetles from the family Scolytidae and flour beetles from the family Tenebrionidae. In addition agronomic and nonagronomic pests include: adults and larvae of the order Dennaptera including earwigs from the family Forficulidae (e.g., European earwig (Forficula auricularia Linnaeus), black earwig (Chelisoches morio Fabricius)); adults and nymphs of the orders Hemiptera and Homoptera such as, plant bugs from the family Miridae, cicadas from the family Cicadidae, leafhoppers (e.g. Empoasca spp.) from the family Cicadellidae, planthoppers from the families Fulgoroidae and Delphacidae, treehoppers from the family Membracidae, psyllids from the family Psyllidae, whiteflies from the family Aleyrodidae, aphids from the family Aphididae, phylloxera from the family Phylloxeridae, mealybugs from the family Pseudococcidae, scales from the families Coccidae, Diaspididae and Margarodidae, lace bugs from the family Tingidae, stink bugs from the family Pentatomidae, cinch bugs (e.g., Blissus spp.) and other seed bugs from the family Lygaeidae, spittlebugs from the family Cercopidae squash bugs from the family Coreidae, and red bugs and cotton stainers from the family Pyrrhocoridae. Also included as agronomic and non-agronomic pests are adults and larvae of the order Acari (mites) such as spider mites and red mites in the family Tetranychidae (e.g., European red mite (Panonychus ulmi Koch), two spotted spider mite (Tetranychus urticae Koch), McDaniel mite (Tetranychus mcdanieli McGregor)), flat mites in the family Tenuipalpidae (e.g., citrus flat mite (Brevipalpus lewisi McGregor)), rust and bud mites in the family Eriophyidae and other foliar feeding mites and mites important in human and animal health, i.e. dust mites in the family Epidermoptidae, follicle mites in the family Demodicidae, grain mites in the family Glycyphagidae, ticks in the order Ixodidae (e.g., deer tick (Ixodes scapularis Say), Australian paralysis tick (Ixodes holhcyclus Neumann), American dog tick (Dermacentor variabilis Say), lone star tick (Amblyomma americanum Linnaeus) and scab and itch mites in the families Psoroptidae, Pyemotidae, and Sarcoptidae; adults and immatures of the order Orthoptera including grasshoppers, locusts and crickets (e.g., migratory grasshoppers (e.g., Melanoplus sanguinipes Fabricius, M. differentials Thomas), American grasshoppers (e.g., Schistocerca americana Drury), desert locust (Schistocerca gregaria Forskal), migratory locust (Locusta migratoria Linnaeus), house cricket (Acheta domesticus Linnaeus), mole crickets (Gryllotalpa spp.)); adults and imnmatures of the order Diptera including leafiniers, midges, fruit flies (Tephritidae), frit flies (e.g., Oscinella frit Linnaeus), soil maggots, house flies (e.g., Musca domestica Linnaeus), lesser house flies (e.g., Fannia canicularis Linnaeus, F. femoralis Stein), stable flies (e.g., Stomoxys calcitrans Linnaeus), face flies, horn flies, blow flies (e.g., Chrysomya spp., Phormia spp.), and other muscoid fly pests, horse flies (e.g., Tabanus spp.), bot flies (e.g., Gastrophilus spp., Oestrus spp.), cattle grubs (e.g., Hypoderma spp.), deer flies (e.g., Chrysops spp.), keds (e.g., Melophagus ovinus Linnaeus) and other Brachycera, mosquitoes (e.g., Aedes spp., Anopheles spp., Culex spp.), black flies (e.g., Prosimulium spp., Simulium spp.), biting midges, sand flies, sciarids, and other Nematocera; adults and immatures of the order Thysanoptera including onion thrips (Thrips tabaci Lindeman) and other foliar feeding thrips; insect pests of the order Hymenoptera including ants (e.g., red carpenter ant (Camponotus ferrugineus Fabricius), black carpenter ant (Camponotus pennsylvanicus De Geer), Pharaoh ant (Monomorium pharaonis Linnaeus), little fire ant (Wasmannia auropunctata Roger), fire ant (Solenopsis geminata Fabricius), red imported fire ant (Solenopsis invicta Buren), Argentine ant (Iridomyrmex humilis Mayr), crazy ant (Paratrechina longicornis Latreille), pavement ant (Tetramorium caespitum Linnaeus), cornfield ant (Lasius alienus Förster), odorous house ant (Tapiinoma sessile Say)), bees (including carpenter bees), hornets, yellow jackets and wasps; insect pests of the order Isoptera including the eastern subterranean termite (Reticulitermes flavipes Kollar), western subterranean termite (Reticulitermes hesperus Banks), Formosan subterranean termite (Coptotermes formosanus Shiraki), West Indian drywood termite (Incisitermes immigrans Snyder) and other termites of economic importance; insect pests of the order Thysanura such as silverfish (Lepisma saccharina Linnaeus) and firebrat (Thermobia domestica Packard); insect pests of the order Mallophaga and including the head louse (Pediculus humanus capitis De Geer), body louse (Pediculus humanus humanus Linnaeus), chicken body louse (Menacanthus stramineus Nitszch), dog biting louse (Trichodectes canis De Geer), fluff louse (Goniocotes gallinae De Geer), sheep body louse (Bovicola ovis Schrank), short-nosed cattle louse (Haematopinus eurysternus Nitzsch), long-nosed cattle louse (Linognathus vituli Linnaeus) and other sucking and chewing parasitic lice that attack man and animals; insect pests of the order Siphonoptera including the oriental rat flea (Xenopsylla cheopis Rothschild), cat flea (Ctenocephalides felis Bouche), dog flea (Ctenocephalides canis Curtis), hen flea (Ceratophyllus gallinae Schrank), sticktight flea (Echidnophaga gallinacea Westwood), human flea (Pulex irritans Linnaeus) and other fleas afflicting mammals and birds. Additional invertebrate pests covered include: spiders in the order Araneae such as the brown recluse spider (Loxosceles reclusa Gertsch & Mulaik) and the black widow spider (Latiodectus mactans Fabricius), and centipedes in the order Scutigeromorpha such as the house centipede (Scutigera coleoptrata Linnaeus). Compounds of the present invention also have activity on members of the Classes Nematoda, Cestoda, Trematoda, and Acanthocephala including economically important members of the orders Strongylida, Ascaridida, Oxyurida, Rhabditida, Spirurida, and Enoplida such as but not limited to economically important agricultural pests (i.e. root knot nematodes in the genus Meloidogyne, lesion nematodes in the genus Pratylenchus, stubby root nematodes in the genus Trichodorus, etc.) and animal and human health pests (i.e. all economically important flukes, tapeworms, and roundworms, such as Strongylus vulgaris in horses, Toxocara canis in dogs, Haemonchus contortus in sheep, Dirofilaria immitis Leidy in dogs, Anoplocephala perfoliata in horses, Fasciola hepatica Linnaeus in ruminants, etc.).

Compounds of the invention show particularly high activity against pests in the order Lepidoptera (e.g., Alabama argillacea Hübner (cotton leaf worm), Archips argyrospila Walker (fruit tree leaf roller), A. rosana Linnaeus (European leaf roller) and other Archips species, Chilo suppressalis Walker (rice stem borer), Cnaphalocrosis medinalis Guenee (rice leaf roller), Crambus caliginosellus Clemens (corn root webworm), Crambus teterrellus Zincken (bluegrass webworm), Cydia pomonella Linnaeus (codling moth), Earias insulana Boisduval (spiny bollworm), Earias vittella Fabricius (spotted bollworm), Helicoverpa armigera Hübner (American bollworm), Helicoverpa zea Boddie (corn earworm), Heliothis virescens Fabricius (tobacco budworm), Herpetogramma licarsisalis Walker (sod webworm), Lobesia botrana Denis & Schiffermüller (grape berry moth), Pectinophora gossypiella Saunders (pink bollworm), Phyllocnistis citrella Stainton (citrus leafminer), Pieris brassicae Linnaeus (large white butterfly), Pieris rapae Linnaeus (small white butterfly), Plutella xylostella Linnaeus (diamondback moth), Spodoptera exigua Hübner (beet armyworm), Spodoptera litura Fabricius (tobacco cutworm, cluster caterpillar), Spodoptera fiugiperda J. E. Smith (fall armyworm), Trichoplusia ni Hübner (cabbage looper) and Tuta absoluta Meyrick (tomato leafminer)). Compounds of the invention also have commercially significant activity on members from the order Homoptera including: Acyrthisiphon pisum Harris (pea aphid), Aphis craccivora Koch (cowpea aphid), Aphis fabae Scopoli (black bean aphid), Aphis gossypii Glover (cotton aphid, melon aphid), Aphis pomi De Geer (apple aphid), Aphis spiraecola Patch (spirea aphid), Aulacorthum solani Kaltenbach (foxglove aphid), Chaetosiphon fragaefolii Cockerell (strawberry aphid), Diuraphis noxia Kurdjumov/Mordvilko (Russian wheat aphid), Dysaphis plantaginea Paaserini (rosy apple aphid), Eriosoma lanigerum Hausmann (woolly apple aphid), Hyalopterus pruni Geoffroy (mealy plum aphid), Lipaphis erysimi Kaltenbach (turnip aphid), Metopolophium dirrhodum Walker (cereal aphid), Macrosipum euphorbiae Thomas (potato aphid), Myzus persicae Sulzer (peach-potato aphid, green peach aphid), Nasonovia ribisnigri Mosley (lettuce aphid), Pemphigus spp. (root aphids and gall aphids), Rhopalosiphum maidis Fitch (corn leaf aphid), Rhopalosiphum padi Linnaeus (bird cherry-oat aphid), Schizaphis gramninun Rondani (greenbug), Sitobion avenae Fabricius (English grain aphid), Therioaphis maculata Buckton (spotted alfalfa aphid), Toxoptera aurantii Boyer de Fonscolombe (black citrus aphid), and Toxoptera citricida Kirkaldy (brown citrus aphid); Adelges spp. (adelgids); Phylloxera devastatrix Pergande (pecan phylloxera); Bemisia tabaci Gennadius (tobacco whitefly, sweetpotato whitefly), Bemisia argentifoli Bellows & Perring (silverleaf whitefly), Dialeurodes citri Ashmead (citrus whitefly) and Trialeurodes vaporariorum Westwood (greenhouse whitefly); Empoasca fabae Harris (potato leafhopper), Laodelphax striatellus Fallen (smaller brown planthopper), Macrolestes quadrilineatus Forbes (aster leafhopper), Nephotettix cinticeps Uhler (green leafhopper), Nephotettix nigropictus Stål (rice leafhopper), Nilaparvata lugens Stål (brown planthopper), Peregrinus maidis Ashmead (corn planthopper), Sogatella furcifera Horvath (white-backed planthopper), Sogatodes orizicola Muir (rice delphacid), Typhlocyba pomaria McAtee white apple leafhopper, Erythroneoura spp. (grape leafhoppers); Magicidada septendecim Linnaeus (periodical cicada); Iceiya purchasi Maskell (cottony cushion scale), Quadraspidiotus perniciosus Comstock (San Jose scale); Planococcus citri Risso (citrus mealybug); Pseudococcus spp. (other mealybug complex); Cacopsylla pyricola Foerster (pear psylla), Trioza diospyri Ashmead (persimmon psylla). These compounds also have activity on members from the order Hemiptera including: Acrosternum hilare Say (green stink bug), Anasa tristis De Geer (squash bug), Blissus leucopterus leucopterus Say (chinch bug), Corythuca gossypii Fabricius (cotton lace bug), Cyrtopeltis modesta Distant (tomato bug), Dysdercus suturellus Herrich-Schäffer (cotton stainer), Euchistus servus Say (brown stink bug), Euchistus variolarius Palisot de Beauvois (one-spotted stink bug), Graptosthetus spp. (complex of seed bugs), Leptoglossus corculus Say (leaf-footed pine seed bug), Lygus lineolaris Palisot de Beauvois (tarnished plant bug), Nezara viridula Linnaeus (southern green stink bug), Oebalus pugnax Fabricius (rice stink bug), Oncopeltus fasciatus Dallas (large milkweed bug), Pseudatomoscelis seriatus Reuter (cotton fleahopper). Other insect orders controlled by compounds of the invention include Thysanoptera (e.g., Frankliniella occidentalis Pergande (western flower thrip), Scirthothrips citri Moulton (citrus thrip), Sericothrips variabilis Beach (soybean thrip), and Thrips tabaci Lindeman (onion thrip); and the order Coleoptera (e.g., Leptinotarsa decemlineata Say (Colorado potato beetle), Epilachna varivestis Mulsant (Mexican bean beetle) and wireworms of the genera Agriotes, Athous or Limonius).

Compounds of this invention can also be mixed with one or more other biologically active compounds or agents including insecticides, fungicides, nematocides, bactericides, acaricides, growth regulators such as rooting stimulants, chemosterilants, semiochemicals, repellents, attractants, pheromones, feeding stimulants, other biologically active compounds or entomopathogenic bacteria, virus or fungi to form a multi-component pesticide giving an even broader spectrum of agronomic and non-agronomic utility. Thus the present invention also pertains to a composition comprising a biologically effective amount of a compound of Formula 1 and an effective amount of at least one additional biologically active compound or agent and can further comprise at least one of a surfactant, a solid diluent or a liquid diluent. Examples of such biologically active compounds or agents with which compounds of this invention can be formulated are: insecticides such as abamectin, acephate, acetamiprid, amidoflumet, avermectin, azadirachtin, azinphos-methyl, bifenthrin, binfenazate, buprofezin, carbofuran, chlorfenapyr, chlorfluazuron, chlorpyrifos, chlorpyrifos-methyl, chromafenozide, clothianidin, cyfluthrin, beta-cyfluthrin, cyhalothrin, lambda-cyhalothrin, cypermethrin, cyromazine, deltamethrin, diafenthiuron, diazinon, diflubenzuron, dimethoate, diofenolan, emamectin, endosulfan, esfenvalerate, ethiprole, fenothicarb, fenoxycarb, fenpropathrin, fenvalerate, fipronil, flonicamid, flucythrinate, tau-fluvalinate, flufenerim, flufenoxuron, fonophos, halofenozide, hexaflumuron, iruidacloprid, indoxacarb, isofenphos, lufenuron, malathion, metaldehyde, methamidophos, methidathion, methomyl, methoprene, methoxychlor, monocrotophos, methoxyfenozide, nithiazin, novaluron, noviflumuron, oxamyl, parathion, parathion-methyl, permethrin, phorate, phosalone, phosmet, phosphamidon, pirimicarb, profenofos, pymetrozine, pyridalyl, pyriproxyfen, rotenone, spinosad, spiromesifin, sulprofos, tebufenozide, teflubenzuron, tefluthrin, terbufos, tetrachlorvinphos, thiacloprid, thiamethoxam, thiodicarb, thiosultap-sodium, tralomethrin, trichlorfon and triflumuron; fungicides such as acibenzolar, azoxystrobin, benomyl, blasticidin-S, Bordeaux mixture (tribasic copper sulfate), bromuconazole, carpropamid, captafol, captan, carbendazim, chloroneb, chlorothalonil, copper oxychloride, copper salts, cyflufenamid, cymoxanil, cyproconazole, cyprodinil, (S)-3,5-dichloro-N-(3-chloro-1-ethyl-1-methyl-2-oxopropyl)-4-methylbenzamide (RH 7281), diclocymet (S-2900), diclomezine, dicloran, difenoconazole, (S)-3,5-dihydro-5-methyl-2-(methylthio)-5-phenyl-3-(phenylamino)-4H-imidazol-4-one (RP 407213), dimethomorph, dimoxystrobin, diniconazole, diniconazole-M, dodine, edifenphos, epoxiconazole, famoxadone, fenamidone, fenarimol, fenbuconazole, fencaramid (SZX0722), fenpiclonil, fenpropidin, fenpropimorph, fentin acetate, fentin hydroxide, fluazinam, fludioxonil, flumetover (RPA 403397), flumorf/flumorlin (SYP-L190), fluoxastrobin (HEC 5725), fluquinconazole, flusilazole, flutolanil, flutriafol, folpet, fosetyl-aluminum, furalaxyl, furametapyr (S-82658), hexaconazole, ipconazole, iprobenfos, iprodione, isoprothiolane, kasugamycin, kresoxim-methyl, mancozeb, maneb, mefenoxam, mepronil, metalaxyl, metconazole, metominostrobin/fenominostrobin (SSF-126), metrafenone (AC375839), myclobutanil, neo-asozin (ferric methanearsonate), nicobifen (BAS 510), orysastrobin, oxadixyl, penconazole, pencycuron, probenazole, prochloraz, propamocarb, propiconazole, proquinazid (DPX-KQ926), prothioconazole (JAU 6476), pyrifenox, pyraclostrobin, pyrimethanil, pyroquilon, quinoxyfen, spiroxamine, sulfur, tebucdnazole, tetraconazole, thiabendazole, thifluzamide, thiophanate-methyl, thiram, tiadinil, triadimefon, triadimenol, tricyclazole, trifloxystrobin, triticonazole, validamyciin and vinclozolin; nematocides such as aldicarb, oxamyl and fenamiphos; bactericides such as streptomycin; acaricides such as amitraz, chinomethionat, chlorobenzilate, cyhexatin, dicofol, dienochlor, etoxazole, fenazaquin, fenbutatin oxide, fenpropathrin, fenpyroximate, hexythiazox, propargite, pyridaben and tebufenpyrad; and biological agents such as Bacillus thuringiensis including ssp. aizawai and kurstaki, Bacillus thuringiensis delta endotoxin, baculovirus, and entomopathogenic bacteria, virus and fungi. Compounds of this invention and compositions thereof can be applied to plants genetically transformed to express proteins toxic to invertebrate pests (such as Bacillus thuringiensis toxin). The effect of the exogenously applied invertebrate pest control compounds of this invention may be synergistic with the expressed toxin proteins.

A general reference for these agricultural protectants is The Pesticide Manual, 12th Edition, C. D. S. Tomlin, Ed., British Crop Protection Council, Farnham, Surrey, U.K., 2000.

One embodiment of insecticides and acaricides for mixing with compounds of this invention include pyrethroids such as acetamiprid, cypermethrin, cyhalothrin, cyfluthrin, beta-cyfluthrin, esfenvalerate, fenvalerate and tralomethrin; carbamates such as fenothicarb, methomyl, oxamyl and thiodicarb; neonicotinoids such as clothianidin, imidacloprid and thiacloprid; neuronal sodium channel blockers such as indoxacarb; insecticidal macrocyclic lactones such as spinosad, abamectin, avermectin and emamectin; γ-aminobutyric acid (GABA) antagonists such as endosulfan, ethiprole and fipronil; insecticidal ureas such as flufenoxuron and triflumuron; juvenile hormone mimics such as diofenolan and pyriproxyfen; pymetrozine; and amitraz. One embodiment of biological agents for mixing with compounds of this invention include Bacillus thuringiensis and Bacillus thuringiensis delta endotoxin as well as naturally occurring and genetically modified viral insecticides including members of the family Baculoviridae as well as entomophagous fungi.

Another embodiment of mixtures include a mixture of a compound of this invention with acetamiprid; a mixture of a compound of this invention with cyhalothrin; a mixture of a compound of this invention with beta-cyfluthrin; a mixture of a compound of this invention with esfenvalerate; a mixture of a compound of this invention with methomyl; a mixture of a compound of this invention with imidacloprid; a mixture of a compound of this invention with thiacloprid; a mixture of a compound of this invention with indoxacarb; a mixture of a compound of this invention with abamectin; a mixture of a compound of this invention with endosulfan; a mixture of a compound of this invention with ethiprole; a mixture of a compound of this invention with fipronil; a mixture of a compound of this invention with flufenoxuron; a mixture of a compound of this invention with pyriproxyfen; a mixture of a compound of this invention with pymetrozine; a mixture of a compound of this invention with amitraz; a mixture of a compound of this invention with Bacillus thuringiensis and a mixture of a compound of this invention with Bacillus thuringiensis delta endotoxin.

In certain instances, combinations with other invertebrate pest control compounds or agents having a similar spectrum of control but a different mode of action will be particularly advantageous for resistance management. Thus, compositions of the present invention can further comprise a biologically effective amount of at least one additional invertebrate pest control compound or agent having a similar spectrum of control but a different mode of action. Contacting a plant genetically modified to express a plant protection compound (e.g., protein) or the locus of the plant with a biologically effective amount of a compound of invention can also provide a broader spectrum of plant protection and be advantageous for resistance management.

Invertebrate pests are controlled in agronomic and nonagronomic applications by applying one or more of the compounds of this invention, in an effective amount, to the environment of the pests including the agronomic and/or nonagronomic locus of infestation, to the area to be protected, or directly on the pests to be controlled. Thus, the present invention further comprises a method for the control of invertebrates in agronomic and/or nonagronomic applications, comprising contacting the invertebrates or their environment with a biologically effective amount of one or more of the compounds of the invention, or with a composition comprising at least one such compound or a composition comprising at least one such compound and an effective amount of at least one additional biologically active compound or agent. Examples of suitable compositions comprising a compound of the invention and an effective amount of at least one additional biologically active compound or agent include granular compositions wherein the additional biologically active compound is present on the same granule as the compound of the invention or on granules separate from those of the compound of this invention.

One embodiment of a method of contact is by spraying. Alternatively, a granular composition comprising a compound of the invention can be applied to the plant foliage or the soil. Compounds of this invention can also be effectively delivered through plant uptake by contacting the plant with a composition comprising a compound of this invention applied as a soil drench of a liquid formulation, a granular formulation to the soil, a nursery box treatment or a dip of transplants. Of note is a composition of the present invention applied as a soil drench of a liquid formulation (and a method wherein a plant is contacted with the composition of the present invention applied as a soil drench of a liquid formulation. Compounds can also be effective by topical application of a composition comprising a compound of this invention to the locus of infestation. Other methods of contact include application of a compound or a composition of the invention by direct and residual sprays, aerial sprays, gels, seed coatings, microencapsulations, systemic uptake, baits, eartags, boluses, foggers, fumigants, aerosols, dusts and many others. The compounds of this invention can also be impregnated into materials for fabricating invertebrate control devices (e.g., insect netting). Seed coatings can be applied to all types of seeds, including those from which plants genetically transformed to express specialized traits will germinate. Representative examples include those expressing proteins toxic to invertebrate pests, such as Bacillus thuringensis toxin or those expressing herbicide resistance, such as “Roundup Ready” seed.

The compounds of this invention can be incorporated into a bait composition that is consumed by an invertebrate pest or used within a device such as a trap, a bait station, and the like. Such a bait composition can be in the form of granules which comprise (a) an active ingredient, namely a compound of Formula 1, an N-oxide, or agronomic or nonagronomic suitable salt thereof, (b) one or more food materials, optionally (c) an attractant, and optionally (d) one or more humectants. Granules or bait compositions which comprise between about 0.001-5% active ingredient; about 40-99% food material and/or attractant; and optionally about 0.05-10% humectants; can be effective in controlling soil invertebrate pests at very low application rates, particularly at doses of active ingredient that are lethal by ingestion rather than by direct contact. Some food materials can function both as a food source and as an attractant. Food materials include carbohydrates, proteins and lipids. Examples of food materials include vegetable flour, sugar, starches, defatted corn grits, animal fat, vegetable oil, such as soybean oil and/or corn oil, yeast extracts and milk solids. Examples of attractants include odorants and flavorants, such as fruit or plant extracts, perfume, or other animal or plant components, pheromones, or other agents known to attract a target invertebrate pest. Examples of humectants, i.e. moisture retaining agents, include glycols and other polyols, glycerine and sorbitol. Of note is a bait composition (and a method utilizing such a bait composition) used to control an invertebrate pest including individually or in combinations ants, termites, and cockroaches. A device for controlling an invertebrate pest can comprise the present bait composition and a housing adapted to receive the bait composition, wherein the housing has at least one opening sized to permit the invertebrate pest to pass through the opening so the invertebrate pest can gain access to the bait composition from a location outside the housing, and wherein the housing is further adapted to be placed in or near a locus of potential or known activity for the invertebrate pest.

The compounds of this invention can be applied in their pure state, but most often application will be of a formulation comprising one or more compounds with suitable carriers, diluents, and surfactants and possibly in combination with a food material depending on the contemplated end use. One embodiment of a method of application involves spraying a water dispersion or refined oil solution of the compounds. Combinations with spray oils, spray oil concentrations, spreader stickers, adjuvants, other solvents, and synergists such as piperonyl butoxide can enhance compound efficacy. For nonagronomic uses such sprays can be applied from spray containers such as a can, a bottle or other container, either by means of a pump or by releasing it from a pressurized container, e.g. a pressurized aerosol spray can. Such spray compositions can take various forms which can include sprays, mists, foams, fumes or fog. Such spray compositions thus can further comprise a carrier which can include a propellant, a foaming agent, or water, as the case may be. Of note is a spray composition comprising a compound or composition of the present invention and a carrier. One embodiment of such a spray composition comprises a compound or composition of the present invention and a propellant. Representative propellants include, but are not limited to, methane, ethane, propane, isopropane, butane, isobutene, butane, pentane, isopentane, neopentane, pentene, a hydrofluorocarbon, a chlorofluorocarbon, dimethyl ether, and mixtures of the foregoing. Of note is a spray composition (and a method utilizing such a spray composition dispensed from a spray container) used to control an invertebrate pest including individually or in combinations mosquitoes, black flies, stable flies, deer flies, horse flies, wasps, yellow jackets, hornets, ticks, spiders, ants, gnats, and the like.

The rate of application required for effective control (i.e. “biologically effective amount”) will depend on such factors as the species of invertebrate to be controlled, the pest's life cycle, life stage, its size, location, time of year, host crop or animal, feeding behavior, mating behavior, ambient moisture, temperature, and the like. Under normal circumstances, application rates of about 0.01 to 2 kg of active ingredient per hectare are sufficient to control pests in agronomic ecosystems, but as little as 0.0001 kg/hectare may be sufficient or as much as 8 kg/hectare may be required. For nonagronomic applications, effective use rates will range from about 1.0 to 50 mg/square meter but as little as 0.1 mg/square meter may be sufficient or as much as 150 mg/square meter may be required. One skilled in the art can easily determine the biologically effective amount necessary for the desired level of invertebrate pest control.

The following TESTS demonstrate the control efficacy of compounds of this invention on specific pests. “Control efficacy” represents inhibition of invertebrate pest development (including mortality) that causes significantly reduced feeding. The pest control protection afforded by the compounds is not limited, however, to these species. See Index Table A for compound descriptions. The following abbreviations are used in the Index Tables which follow: i is iso, Me is methyl, Pr is propyl, i-Pr is isopropyl, and CN is cyano. The abbreviation “Ex.” stands for “Example” and is followed by a number indicating in which example the compound is prepared.

INDEX TABLE A

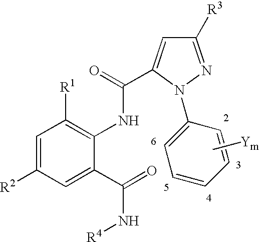

| Compound | R¹ | R² | R³ | R⁴ | Yₘ | m.p. (° C.) |
|---|---|---|---|---|---|---|
| 1(Ex. 1) | Me | CN | Br | i-Pr | 2-Cl | 145-149 |
| 2(Ex. 2) | Me | CN | Br | Me | 2-Cl | 242-243 |
| 3(Ex. 3) | Cl | Cl | Br | Me | 2-Cl | 209-210 |
| 4 | Me | Br | CF₃ | i-Pr | 2-F | 232-233 |
| 5 | Me | Br | CF₃ | t-Bu | 2-Cl | 260-260 |
| 6 | Br | Br | CF₃ | i-Pr | 2-Cl | 233-234 |
| 7 | Me | Br | Br | t-Bu | 2-Cl | 239-241 |
| 8 | Me | Br | Br | Me | 2-Cl | 150-152 |
| 9 | Me | Br | Br | Et | 2-Cl | 223-225 |
| 10 | Me | Br | Br | i-Pr | 2-Cl | 197-198 |
| 11 | Me | Br | Br | propargyl | 2-Cl | 187-188 |
| 12 | Me | Br | CF₃ | i-Pr | 2,6-di-Cl | 230-233 |
| 13 | Me | Br | CF₃ | t-Bu | 2,6-di-Cl | 250-250 |
| 14 | Me | Br | CF₃ | Me | 2,6-di-Cl | 228-230 |
| 15 | Me | Br | CF₃ | propargyl | 2,6-di-Cl | 228-230 |
| 16 | Cl | Cl | CF₃ | i-Pr | 2-Cl | 223-224 |
| 17 | Me | Br | CF₃ | i-Pr | 2,6-di-Cl | 250-250 |
| 18 | Cl | Br | CF₃ | i-Pr | 2,6-di-Cl | 251-253 |
| 19 | Cl | Cl | CF₃ | Me | 2-Cl | 232-233 |
| 20 | Cl | Cl | CF₃ | Et | 2-Cl | 247-248 |
| 21 | Cl | Cl | CF₃ | t-Bu | 2-Cl | 223-224 |
| 22 | Cl | Cl | CF₃ | propargyl | 2-Cl | 229-231 |
| 23 | Me | Cl | Cl | i-Pr | 2-Cl | 180-181 |
| 24 | Me | Br | Br | i-Pr | 2,6-di-Cl | 238-239 |
| 25 | Me | Cl | Br | Me | 2-Cl,4-F | 250-25 1 |
| 26 | Me | Cl | Br | H | 2-Cl,4-F | 229-229 |
| 27 | Me | Cl | Br | i-Pr | 2-Cl,4-F | 189-190 |
| 28 | Me | Cl | Br | t-Bu | 2-Cl,4-F | 247-249 |
| 29 | Me | Cl | OCF₂H | i-Pr | 2-Cl | 177-179 |
| 30 | Me | Cl | OCH₂CF₃ | Et | 2-Cl | 184-186 |
| 31 | Me | Cl | OCH₂CF₃ | i-Pr | 2-Cl | 196-198 |
| 32 | Me | Br | OCH₂CF₃ | Me | 2-Cl | 220-223 |
| 33 | Me | CN | Br | Me | 2,6-di-Cl | 201-202 |
| 34 | Me | CN | Br | H | 2,6-di-Cl | 250-250 |
| 35 | Me | CN | CF₃ | Me | 2,6-di-Cl | 215-216 |
| 36 | Cl | Cl | CF₃ | Me | 2,6-di-Me | 245-247 |
| 37 | Cl | Cl | CF₃ | i-Pr | 2,6-di-Me | 244-245 |
| 38 | Me | CN | CF₃ | Me | 2,6-di-Me | 243-243 |
| 39 | Me | CN | CF₃ | i-Pr | 2,6-di-Me | 217-218 |
| 40 | Me | Cl | CF₃ | Me | 2,6-di-Me | 242-243 |
| 41 | Me | Cl | CF₃ | i-Pr | 2,6-di-Me | 240-241 |
| 42 | Cl | CN | CF₃ | Me | 2-Cl | 234-23 5 |
| 43 | Cl | CN | CF₃ | i-Pr | 2-Cl | 149-150 |
| 44 | Br | CN | Br | Me | 2-Cl | 189-190 |
| 45 | Br | CN | Br | i-Pr | 2-Cl | 162-163 |
| 46 | Cl | CN | Br | Me | 2-Cl | 172-173 |
| 47 | Cl | CN | Br | i-Pr | 2-Cl | 148-149 |
| 48 | Cl | CN | Br | H | 2-Cl | 152-154 |
| 49 | Br | Br | Br | Me | 2-Cl | 227-228 |
| 50 | Br | CN | CF₃ | Me | 2,6-di-Cl | 210-212 |
| 51 | Br | Br | Br | CH₂CN | 2-Cl | 252-253 |
| 52 | Br | CN | CF₃ | i-Pr | 2,6-di-Cl | 250-250 |
| 53 | Br | CN | Br | Me | 2-F | 215-216 |
| 54 | Br | CN | Br | i-Pr | 2-F | 257-258 |
| 55 | Br | CN | Br | H | 2-F | 250-250 |
| 56 | Br | CN | Br | CH₂CN | 2-F | 250-250 |
| 57 | Cl | Cl | CF₃ | Me | 2,6-di-Cl | 239-243 |
| 58 | Cl | Cl | CF₃ | i-Pr | 2,6-di-Cl | 242-244 |
| 59 | Cl | Cl | CF₃ | H | 2,6-di-Cl | 192-194 |
| 60 | Cl | Cl | Br | Me | 2-F | 240-24 1 |
| 61 | Cl | Cl | Br | i-Pr | 2-F | 250-250 |
| 62 | Cl | CN | Br | Me | 2-F | 205-207 |
| 63 | Cl | CN | Br | i-Pr | 2-F | 250-250 |
| 64 | Cl | CN | Br | H | 2-F | 250-250 |
| 65 | Br | Br | Br | i-Pr | 2-Cl | 198-199 |
| 66 | Br | Br | Br | H | 2-Cl | 248-249 |
| 67 | Me | CN | Br | H | 2-Cl | 156-157 |
| 68 | Me | CN | Br | Me | 2-F | 210-211 |
| 69 | Me | CN | Br | i-Pr | 2-F | 247-248 |
| 70 | Br | Br | Br | propargyl | 2-Cl | 220-221 |
| 71 | Me | CN | Br | H | 2-F | 239-240 |
| 72 | Me | CN | Br | propargyl | 2-F | 232-234 |
| 73 | Cl | CN | CF₃ | Me | 2,6-di-Cl | 267-269 |
| 74 | Cl | CN | CF₃ | i-Pr | 2,6-di-Cl | 278-279 |
| 75 | Cl | CN | CF₃ | H | 2,6-di-Cl | 195-198 |
| 76 | Cl | CN | CF₃ | propargyl | 2,6-di-Cl | 202-204 |
| 77 | Cl | CN | CF₃ | CH₂CN | 2,6-di-Cl | 148-150 |
| 78 | I | CN | Br | Me | 2-Cl | 100-101 |
| 79 | Br | Br | Br | CH(CH₃)CH₂SMe | 2-Cl | 165-166 |
| 80 | Cl | Cl | Br | CH₂CN | 2-Cl | 158-159 |
| 81 | Cl | Cl | Br | CH₂CN | 2-Cl | 183-184 |
| 82 | Me | Cl | Br | CH₂CN | 2-Cl | 112-114 |
| 83 | Me | Cl | Br | Me | 2-Cl | 162-163 |
| 84 | Cl | Cl | Cl | Me | 2-Cl | 23 1-232 |
| 85 | Me | CN | Cl | Me | 2-Cl | 222-223 |
| 86 | Me | CN | CF₃ | Me | 2-Cl | 23 3-234 |
| 87 | Me | CN | CF₃ | t-Bu | 2-Cl | 250-250 |
| 88 | Cl | Cl | Cl | CH₂CN | 2-Cl | 222-223 |
| 89 | Me | CN | CF₃ | H | 2-Cl | 143-144 |
| 90 | Me | CN | CF₃ | i-Pr | 2-Cl | 254-255 |
| 91 | Me | CN | Br | Me | 2,4,6-tri-Cl | 253-254 |
| 92 | Me | CN | Br | H | 2,4,6-tri-Cl | 251-253 |
| 93 | Cl | Cl | Br | Me | 2,4,6-tri-Cl | 163-164 |
| 94 | Cl | Cl | Br | Me | 2,4-di-Cl | 258-259 |
| 95 | Me | CN | Br | i-Pr | 2,4-di-Cl | 250-250 |
| 96 | Me | CN | Br | Me | 2,4-di-Cl | 259-269 |
| 97 | Me | CN | Br | H | 2,4-di-Cl | 228-229 |
| 98 | Me | CN | Br | i-Pr | 2,4,6-tri-Cl | 168-169 |
| 99 | Cl | Cl | Br | i-Pr | 2,4-di-Cl | 251-252 |
| 100 | Cl | Cl | Br | H | 2,4-di-Cl | 168-169 |
| 101 | Me | CN | Br | t-Bu | 2-Cl | 250-250 |
| 102 | Me | CN | Br | i-Pr | 2-Cl,4-F | 250-250 |
| 103 | Cl | Cl | Br | i-Pr | 2-Cl,4-F | 192-193 |
| 104 | Me | CN | Br | Me | 2-Cl,4-F | 237-238 |
| 105 | Cl | Cl | Br | Me | 2-Cl,4-F | 234-235 |
| 106 | Me | CN | Br | H | 2-Cl,4-F | 250-250 |
| 107 | Cl | Cl | Br | H | 2-Cl,4-F | 244-245 |
| 108 | Me | CN | Cl | i-Pr | 2-Cl | 146-147 |
| 109 | Me | CN | Cl | H | 2-Cl | 167-168 |
| 110 | Me | CN | Cl | i-Pr | 2-Cl,4-F | 250-250 |
| 111 | Me | CN | Cl | Me | 2,6-di-Cl,4-Me | 247-248 |
| 112 | Me | CN | Cl | i-Pr | 2,6-di-Cl,4-Me | 243-244 |
| 113 | Me | CN | Cl | Me | 2,4-di-Cl,6-Me | 249-250 |
| 114 | Me | CN | Cl | i-Pr | 2,4-di-Cl,6-Me | 234-235 |
| 115 | Cl | Cl | Cl | Me | 2-Cl,4-F | 220-221 |
| 116 | Me | CN | CF₃ | Me | 2,4,6-tri-Cl | 258-259 |
| 117 | Me | CN | CF₃ | i-Pr | 2,4,6-tri-Cl | 253-254 |
| 118 | Me | CN | CF₃ | H | 2,4,6-tri-Cl | 235-236 |
| 119 | Cl | Cl | CF₃ | Me | 2,4,6-tri-Cl | 218-219 |
| 120 | Cl | Cl | CF₃ | i-Pr | 2,4,6-tri-Cl | 196-197 |
| 121 | Cl | Cl | CF₃ | H | 2,4,6-tri-Cl | 238-239 |
| 122 | Me | CN | Cl | Me | 2,4,6-tri-Cl | 248-249 |
| 123 | Me | CN | Cl | i-Pr | 2,4,6-tri-Cl | 220-221 |
| 124 | Cl | Cl | Cl | Me | 2,4,6-tri-Cl | 156-158 |
| 125 | Cl | Cl | Cl | i-Pr | 2,4,6-tri-Cl | 148-149 |
| 126 | Me | CN | Cl | Me | 2,6-di-Cl | 216-217 |
| 127 | Me | CN | Cl | i-Pr | 2,6-di-Cl | 229-230 |
| 128 | Cl | Cl | Cl | H | 2,4,6-tri-Cl | 242-243 |
| 129 | Cl | Cl | Cl | i-Pr | 2-Cl,4-F | 194-195 |
| 130 | Cl | Cl | Cl | H | 2-Cl,4-F | 127-128 |
| 131 | Me | CN | Cl | H | 2-Cl,4-F | 155-156 |
| 132 | Me | CN | Cl | Me | 2-Cl,4-F | 125-156 |

### BIOLOGICAL EXAMPLES OF THE INVENTION

### Test A

For evaluating control of diamondback moth (Plutella xylostella) the test unit consisted of a small open container with a 12-14-day-old radish plant inside. This was pre-infested with 10-15 neonate larvae on a piece of insect diet by use of a core sampler to remove a plug from a sheet of hardened insect diet having many larvae growing on it and transfer the plug containing larvae and diet to the test unit. The larvae moved onto the test plant as the diet plug dried out.

Test compounds were formulated using a solution containing 10% acetone, 90% water and 300 ppm X-77TM Spreader Lo-Foam Formula non-ionic surfactant containing alkylarylpolyoxyethylene, free fatty acids, glycols and isopropanol (Loveland Industries, Inc. Greeley, Colo., USA). The formulated compounds were applied in 1 mL of liquid through a SUJ2 atomizer nozzle with ⅛ JJ custom body (Spraying Systems Co. Wheaton, Ill., USA) positioned 1.27 cm (0.5 inches) above the top of each test unit. All experimental compounds in these tests were sprayed at 50 ppm replicated three times. After spraying of the formulated test compound, each test unit was allowed to dry for 1 hour and then a black, screened cap was placed on top. The test units were held for 6 days in a growth chamber at 25° C. and 70% relative humidity. Plant feeding damage was then visually assessed based on foliage consumed.

Of the compounds tested, the following provided very good to excellent levels of plant protection (20% or less feeding damage): 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102 and 103.

### Test B

For evaluating control of fall armyworm (Spodoptera frugiperda) the test unit consisted of a small open container with a 4-5-day-old corn (maize) plant inside. This was pre-infested (using a core sampler) with 10-15 1 -day-old larvae on a piece of insect diet.

Test compounds were formulated and sprayed at 50 ppm as described for Test A. The applications were replicated three times. After spraying, the test units were maintained in a growth chamber and then visually rated as described for Test A.

Of the compounds tested, the following provided excellent levels of plant protection (20% or less feeding damage): 1, 2, 3, 4, 5, 6, 7, 8, 9, 10, 11, 12, 13, 14, 15, 16, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 57, 58, 59, 60, 61, 62, 63, 65, 66, 67, 68, 69, 70, 71, 72, 74, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 113, 114, 115, 120, 121, 122, 123, 124, 125, 126, 127, 128, 129, 130, 131 and 132.

### Test C

For evaluating control of green peach aphid (Myzus persicae) through contact and/or systemic means, the test unit consisted of a small open container with a 12-15-day-old radish plant inside. This was pre-infested by placing on a leaf of the test plant 30-40 aphids on a piece of leaf excised from a culture plant (cut-leaf method). The larvae moved onto the test plant as the leaf piece desiccated. After pre-infestation, the soil of the test unit was covered with a layer of sand.

Test compounds were formulated using a solution containing 10% acetone, 90% water and 300 ppm X-77™ Spreader Lo-Foam Formula non-ionic surfactant containing alkylarylpolyoxyethylene, free fatty acids, glycols and isopropanol (Loveland Industries, Inc.). The formulated compounds were applied in 1 mL of liquid through a SUJ2 atomizer nozzle with ⅛ JJ custom body (Spraying Systems Co.) positioned 1.27 cm (0.5 inches) above the top of each test unit. All experimental compounds in this screen were sprayed at 250 ppm, replicated three times. After spraying of the formulated test compound, each test unit was allowed to dry for 1 hour and then a black, screened cap was placed on top. The test units were held for 6 days in a growth chamber at 19-21° C. and 50-70% relative humidity. Each test unit was then visually assessed for insect mortality.

Of the compounds tested, the following resulted in at least 80% mortality: 26, 33, 34, 35, 45, 48, 49, 50, 53, 57, 59, 67, 71, 75, 77, 79, 81, 102, 106, 107, 109, 110, 118, 127, 130 and 131.

### Test D

For evaluating control of potato leafhopper (Empoasca fabae Harris) through contact and/or systemic means, the test unit consisted of a small open container with a 5-6 day old Longio bean plant (primary leaves emerged) inside. White sand was added to the top of the soil and one of the primary leaves was excised prior to application. Test compounds were formulated and sprayed at 250 ppm and replicated three times as described for Test C. After spraying, the test units were allowed to dry for 1 hour before they were post-infested with 5 potato leafhoppers (18 to 21 day old adults). A black, screened cap was placed on the top of the cylinder. The test units were held for 6 days in a growth chamber at 19-21° C. and 50-70% relative humidity. Each test unit was then visually assessed for insect mortality. Of the compounds tested, the following resulted in at least 80% mortality: 11, 12, 19, 20, 34, 55, 59, 67, 75, 77, 79, 81, 83, 85, 87, 88, 105, 106, 107, 109, 118, 120, 121, 130, 131 and 132.

### Test E

For evaluating control of cotton melon aphid (Aphis gossypii) through contact and/or systemic means, the test unit consisted of a small open container with a 6-7-day-old cotton plant inside. This was pre-infested with 30-40 insects on a piece of leaf according to the cut-leaf method described for Test C, and the soil of the test unit was covered with a layer of sand. Test compounds were formulated and sprayed at 250 ppm as described for Test D. The applications were replicated three times. After spraying, the test units were maintained in a growth chamber and then visually rated as described for Test D.

Of the compounds tested, the following resulted in at least 80% mortality: 49, 67, 81, 102, 105, 106, 107, 109, 130, 131 and 132.

### Test F

For evaluating control of corn planthopper (Peregrinus maidis) through contact and/or systemic means, the test unit consisted of a small open container with a 3-4 day old corn (maize) plant (spike) inside. White sand was added to the top of the soil prior to application. Test compounds were formulated and sprayed at 250 ppm and replicated three times as described for Test C. After spraying, the test units were allowed to dry for 1 hour before they were post-infested with 10-20 corn planthoppers (18- to 20-day old nymphs) by sprinkling them onto the sand with a salt shaker. A black, screened cap was placed on the top of the cylinder. The test units were held for 6 days in a growth chamber at 19-21° C. and 50-70% relative humidity. Each test unit was then visually assessed for insect mortality.

Of the compounds tested, the following resulted in at least 80% mortality: 67.

### Test G

For evaluating control of silverleaf whitefly (Bemisia tabaci), the test unit consisted of a 14-21-day-old cotton plant grown in Redi-earth® media (Scotts Co.) with at least two true leaves infested with 2nd and 3rd instar nymphs on the underside of the leaves.

Test compounds were formulated in no more than 2 mL of acetone and then diluted with water to 25-30 mL. The formulated compounds were applied using a flat fan air-assisted nozzle (Spraying Systems 122440) at 10 psi (69 kPa). Plants were sprayed to run-off on a turntable sprayer. All experimental compounds in this screen were sprayed at 250 ppm and replicated three times. After spraying of the test compound, the test units were held for 6 days in a growth chamber at 50-60% relative humidity and 28° C. daytime and 24° C. nighttime temperature. Then the leaves were removed and the dead and live nymphs were counted to calculate percent mortality.

Of the compounds tested, the following resulted in at least 80% mortality: 57, 101, 102, 110 and 127.

### Test H

For evaluating foliar control of tobacco budworm (Heliothis virescens), cotton plants were grown in Metromix potting soil in 10-cm pots in aluminum trays. When the plants reached test size (28 days, 3-4 full leaves) the plants were treated with solution of test compounds.

Test compounds were formulated in 2.0 mL of acetone and then diluted with a water/Ortho X-77™ solution to provide 50 mL of 50 ppm stock solution. Then serial dilutions were made at rates ranging from 10 ppm down to 0.01 ppm.

The treatment solutions were applied to the plants to run off with an air atomizer sprayer. Plants were allowed to dry for 2 hours, and then treated leaves were excised and placed into each cell of a 24-cell tray. One third-instar tobacco budworm larva was introduced into each cell. Each treatment was setup in a separate tray with a total of 24 larvae. The test units were placed on trays and put in a growth chamber at 26° C. and 50% relative humidity for 4 days. Each test units was then visually assessed for larval mortality.

Of the compounds tested, the following compounds provided at least 80% mortality at 10 ppm or lower rates: 1, 2, 3, 4, 5, 6, 7, 8, 9, 10, 11, 12, 13, 14, 15, 16, 19, 23, 24, 25, 27, 45, 46, 47, 49, 51, 54, 65 and 70.

### Test I

For evaluating foliar control of cabbage looper (Trichoplusia ni), cotton plants were grown in Metromix potting soil in 10-cm pots in aluminum trays. When the plants reached test size (28 days, 3-4 fall leaves) the plants were treated with the test compounds.

Test compounds were formulated and sprayed on test plants as described for Test H. After drying for 2 hours, the treated leaves were excised and infested with 24 third-instar cabbage looper larvae as described in Test H. The test units were placed on trays and put in a growth chamber at 26° C. and 50% relative humidity for 4 days. Each test unit was then visually assessed for larval mortality.

Of the compounds tested, the following compounds provided at least 80% mortality at 10 ppm or lower rates: 1, 2, 3, 4, 5, 9, 23, 24, 44, 45, 46, 47, 49, 51, 54, 65 and 70.

### Test J

For evaluating foliar control of beet armyworm (Spodoptera exigua), soybean plants were grown in sassafras soil in 10-cm pots in aluminum trays. When the plants reached test size (21 days, 3 full trifoliates) the plants were treated with the test compounds.

Test compounds were formulated and sprayed on test plants as described for Test H. After drying for 2 hours, the treated leaves were excised and infested with 24 instar beet armyworm larvae as described in Test H. The test units were placed on trays and put in a growth chamber at 26° C., 50% and relative humidity for 4 days. Each test unit was then visually assessed for larval mortality.

Of the compounds tested, the following compounds provided at least 80% mortality at 10 ppm or lower rates: 1, 2, 3, 4, 5, 6, 7, 8, 9, 10, 11, 12, 14, 15, 16, 19, 23, 24, 25, 26, 27, 31, 33, 35, 44, 45, 46, 47, 49, 51, 65 and 70.

What is claimed is:

1. A compound of Formula 1, an N-oxide or a salt thereof 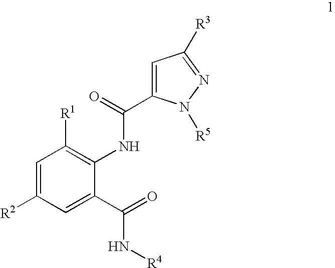
wherein
R¹ is Me, Cl, Br or I;
R² is Cl, Br, I or —CN;
R³ is Cl, Br, CF₃, OCH₂CF₃ or OCF₂H;
R⁴ is H; or C₁-C₄ alkyl, C₂-C₄ alkenyl or C₂-C₄ alkynyl, each optionally substituted with CN or SMe; and
R⁵ is phenyl substituted with 1 to 3 substituents selected from the group consisting of F, Cl, Br and Me.

2. The compound of claim 1 wherein
R² is Cl;
R³ is Cl, Br or CF₃;
R⁴ is Me, Et, i-Pr or t-Bu; and
R⁵ is 2-chlorophenyl, 2-fluorophenyl, 2-bromophenyl, 2,4-dichlorophenyl, 2-chloro-4-fluorophenyl, 2,6-dichlorophenyl, 2,6-difluorophenyl or 2,4,6-trichlorophenyl.

3. The compound of claim 1 wherein:
R² is CN;
R³ is Cl, Br or CF₃;
R⁴ is Me, Et, i-Pr or t-Bu; and
R⁵ is 2-chlorophenyl, 2-fluorophenyl, 2-bromophenyl, 2,4-dichlorophenyl, 2-chloro-4-fluorophenyl, 2,6-dichlorophenyl, 2,6-difluorophenyl or 2,4,6-trichlorophenyl.

4. A composition for controlling an invertebrate pest comprising a biologically effective amount of a compound of claim 1 and at least one additional component selected from the group consisting of a surfactant, a solid diluent and a liquid diluent, said composition optionally further comprising an effective amount of at least one additional biologically active compound or agent.

5. A composition of claim 4 wherein at least one additional biologically active compound or agent is selected from insecticides of the group consisting of pyrethroids, carbamates, neonicotinoids, neuronal sodium channel blockers, insecticidal macrocyclic lactones, γ-aminobutyric acid antagonists, insecticidal ureas, juvenile hormone mimics, members of Bacillus thuringiensis, Bacillus thuringiensis delta endotoxin, and naturally occurring or genetically modified viral insecticides.

6. The composition of claim 4 wherein the at least one additional biologically active compound or agent is selected from the group consisting of abamectin, acephate, acetamiprid, acetoprole, amidoflumet, avermectin, azadirachtin, azinphos-methyl, bifenthrin, bifenazate, bistrifluron, buprofezin, carbofuran, chlorfenapyr, chlorfluazuron, chlorpyrifos, chlorpyrifos-methyl, chromafenozide, clothianidin, cyfluthrin, beta-cyfluthrin, cyhalothrin, lambda-cyhalothrin, cypermethrin, cyromazine, deltamethrin, diafenthiuron, diazinon, diflubenzuron, dimethoate, dinotefuran, diofenolan, emamectin, endosulfan, esfenvalerate, ethiprole, fenothicarb, fenoxycarb, fenpropathrin, fenvalerate, fipronil, flonicamid, flucythrinate, tau-fluvalinate, flufenerim, flufenoxuron, gamma-chalothrin, halofenozide, hexaflumuron, imidacloprid, indoxacarb, isofenphos, lufenuron, malathion, metaldehyde, methamidophos, methidathion, methomyl, methoprene, methoxychlor, methoxyfenozide, metofluthrin, monocrotophos, methoxyfenozide, novaluron, noviflumuron, oxamyl, parathion, parathion-methyl, pennethrin, phorate, phosalone, phosmet, phosphamidon, pirimicarb, profenofos, profluthrin, protrifenbute, pymetrozine, pyridalyl, pyriproxyfen, rotenone, spinosad, spiromesifen, sulprofos, tebufenozide, teflubenzuron, tefluthrin, terbufos, tetrachlorvinphos, thiacloprid, thiamethoxam, thiodicarb, thiosultap-sodium, tolfenpyrad, tralomethrin, trichlorfon, triflumuron, aldicarb, fenamiphos, amitraz, chinomethionat, chlorobenzilate, cyhexatin, dicofol, dienochlor, etoxazole, fenazaquin, fenbutatin oxide, fenpyroximate, hexythiazox, propargite, pyridaben, tebufenpyrad, Bacillus thuringiensis aizawai, Bacillus thuringiensis kurstaki, Bacillus thuringiensis delta endotoxin, baculovirus, entomopathogenic bacteria, entomopathogenic virus and entomopathogenic fungi.

7. The composition of claim 4 wherein the at least one additional biologically active compound or agent is selected from the group consisting of cypermethrin, cyhalothrin, cyfluthrin and beta-cyfluthrin, esfenvalerate, fenvalerate, tralomethrin, fenothicarb, methomyl, oxamyl, thiodicarb, acetamiprid, clothianidin, imidacloprid, thiamethoxam, thiacloprid, indoxacarb, spinosad, abamectin, avermectin, emamectin, endosulfan, ethiprole, fipronil, flufenoxuron, triflumuron, diofenolan, pyriproxyfen, pymetrozine, amitraz, Bacillus thuringiensis aizawai, Bacillus thuringiensis kurstaki, Bacillus thuringiensis delta endotoxin and entomophagous fungi.

8. A method for controlling an invertebrate pest comprising contacting the invertebrate pest or its environment with a biologically effective amount of a compound of claim 1.

9. A method for controlling an invertebrate pest comprising contacting the invertebrate pest or its environment with a biologically effective amount of a composition of claim 4.

10. The method of claim 8 or claim 9 wherein the invertebrate pest is a cockroach, an ant or a termite which is contacted by the compound by consuming a bait composition comprising the compound.

11. The method of claim 8 or claim 9 wherein the invertebrate pest is a mosquito, a black fly, a stable, fly, a deer fly, a horse fly, a wasp, a yellow jacket, a hornet, a tick, a spider, an ant, or a gnat which is contacted by a spray composition comprising the compound dispensed from a spray container.

12. The method of claim 9 wherein a plant is contacted with the composition applied as a soil drench of a liquid formulation.

13. The composition of claim 4 in the form of a soil drench liquid formulation.

14. A spray composition, comprising:
(a) a compound of claim 1; and
(b) a propellant.

15. A bait composition, comprising:
(a) a compound of claim 1;
(b) one or more food materials;
(c) optionally an attractant; and
(d) optionally a humectant.

16. A device for controlling an invertebrate pest, comprising:
(a) the bait composition of claim 15; and
(b) a housing adapted to receive the bait composition, wherein the housing has at least one opening sized to permit the invertebrate pest to pass through the opening so the invertebrate pest can gain access to the bait composition from a location outside the housing, and wherein the housing is further adapted to be placed in or near a locus of potential or known activity for the invertebrate pest.
